(19) United States
(12) Patent Application Publication
(10) Pub. No.: US 2018/0318886 A1
(43) Pub. Date: Nov. 8, 2018

(54) SHOWER-CLEANING SYSTEM

(71) Applicant: AS IP Holdco, LLC, Piscataway, NJ (US)

(72) Inventors: Alanna Wing LIBBRECHT, Madison, NJ (US); Verne MYERS, Clinton, NJ (US); Steven KAPPUS, Manville, NJ (US); Douglas LEAVITT, Bethlehem, PA (US); Scott ROTE, Mokena, IL (US); Mark KURTH, La Porte, IN (US); Nathan WICKER, Chicago, IL (US); David WYLEN, Chicago, IL (US); Timothy J. PAYNE, Columbus, OH (US)

(73) Assignee: AS IP Holdco, LLC, Piscataway, NJ (US)

(21) Appl. No.: 15/973,414

(22) Filed: May 7, 2018

Related U.S. Application Data
(60) Provisional application No. 62/651,047, filed on Mar. 30, 2018.
(60) Provisional application No. 62/503,133, filed on May 8, 2017.

(51) Int. Cl. B08B 3/02; B05B 1/18

(52) U.S. Cl. CPC B08B 3/02; B05B 1/185

(57) ABSTRACT

Systems, methods, and techniques for cleaning shower-enclosures are provided. In some embodiments, a shower-cleaning showerhead comprises a diverter housed in the showerhead, wherein the diverter is configured to divert water toward either a shower face of the showerhead or toward a cleaning nozzle of the showerhead. Before being expelled from the cleaning nozzle, water from the water supply may be mixed with cleaning solution, which may be pumped into the water supply or may be drawn in by the Venturi effect. In some embodiments, the showerhead may be configured to direct the flow of water along different flow paths in accordance with a shower mode, a cleaning mode, a rinse mode, and/or a pause mode. In some embodiments, one or more valves of the showerhead may be electronically and/or manually controlled.

### REFERENCE TO RELATED APPLICATIONS

This application claims the benefit of U.S. Provisional Application No. 62/503,133, filed May 8, 2017, and U.S. Provisional Application No. 62/651,047, filed Mar. 30, 2018, the entire contents of each of which are incorporated herein by reference.

### FIELD OF THE INVENTION

This relates to shower-cleaning systems and, particularly, to plumbing-integrated shower-cleaning systems.

### BACKGROUND OF THE INVENTION

Shower enclosures must be regularly cleaned to prevent the buildup of dirt and other contaminants, soap residue, and water-marks. The most common solution to the need to clean shower enclosures is for a user to stand in or near a shower enclosure and manually apply detergent to the shower enclosure and to then manually scrub and rinse the shower enclosure. Other known solutions to the need to clean shower enclosures is to clean shower enclosures with tank-based systems that dispense water from a tank that must be manually refilled by a user.

### SUMMARY OF THE INVENTION

As discussed above, the most common solution to the need to clean a shower enclosure is for a user to stand in or near the shower enclosure and manually clean the enclosure by hand. This solution is tiresome, time-consuming, and unsanitary; it exposes users to potentially harsh chemicals during the cleaning process and exposes the user to the risk of a slip and fall during the cleaning process.

As discussed above, other solutions to the need to clean shower enclosures make use of systems having refillable water tanks that must be manually replaced or refilled by a user. These systems are also tiresome, inconvenient, and physically burdensome in that they require users to manually and repeatedly refill water tanks.

Accordingly, there is a need for improved systems, methods, and techniques for cleaning shower enclosures. Particularly, there is a need for systems, methods, and techniques for cleaning shower enclosures that reduce or eliminate the tiresome and time-consuming manual cleaning process and/or tank refilling process required for known solutions; and there is a need for systems, methods, and techniques for cleaning shower enclosures that protect users from harsh chemicals and slip-and-fall risks during a cleaning process and/or tank refilling process.

Shower-cleaning systems that may address the above needs are provided herein. As described in detail herein, a shower-cleaning system may be integrated into the plumbing of the shower system itself. The shower-cleaning system may be implemented as a shower-cleaning showerhead, a shower-cleaning shower column, and/or a shower-cleaning shower valve. The shower-cleaning systems described herein may harness the flow of water that would normally be directed to a shower face (e.g., the face of a showerhead) and redirect the flow to a cleaning nozzle. The water flow may be mixed with a cleaning detergent or other cleaning chemical before being dispensed through the cleaning valve.

The shower-cleaning system may be operable to be automatically controlled by a microchip or other computerized system such that a cleaning cycle may be started by a user's input (e.g., turning a knob, pressing a button, entering a command to a computer interface, etc.) and may last for a predetermined period of time. For example, a user may activate a clean cycle in which detergent and water are dispensed from the cleaning nozzle, and the cleaning cycle may be automatically followed by a water-only rinse cycle using the cleaning nozzle. After the rinse cycle, the system may automatically deactivate the cleaning nozzle and direct all water flow back to the shower face.

Systems, methods, and techniques described herein may be advantageous because they may allow a user to be able to keep a shower enclosure cleaner for longer than by using manual cleaning processes, may enable removal of soap scum and mildew from shower enclosures, may enable disinfection of shower enclosures, and may enable prevention and removal of water spots from shower enclosures.

In some embodiments, a shower-cleaning showerhead is provided, the shower-cleaning showerhead comprising: a showerhead housing comprising a showerhead face and a cleaning nozzle; and a diverter located inside the showerhead housing and configured to be fluidly connected to a water supply of a shower, the showerhead face, and the cleaning nozzle; wherein the cleaning nozzle is configured to be fluidly connected to a supply of a cleaning agent of the showerhead such that the cleaning agent mixes with water of the water supply to create a mixture that flows out of the cleaning nozzle; wherein the diverter is configured to selectably prevent and allow flow of water of the water supply to each of the shower face and the cleaning nozzle.

In some embodiments of the shower-cleaning showerhead, the supply of cleaning agent comprises a container configured to be attached to a receiving portion of the showerhead.

In some embodiments of the shower-cleaning showerhead, the container comprises a rigid bottle having an outlet configured to allow the cleaning agent to flow out of the bottle and an inlet configured to allow air to flow into the bottle.

In some embodiments of the shower-cleaning showerhead, the container comprises a flexible bag configured to be collapsible.

In some embodiments of the shower-cleaning showerhead, the supply of cleaning agent comprises a solid tablet of concentrated cleaning agent configured to dissolve and mix with the water of the water supply.

In some embodiments, the shower-cleaning showerhead comprises an electric pump configured to cause the cleaning agent to flow into the water of the water supply.

In some embodiments of the shower-cleaning showerhead, the cleaning agent is configured to flow into the water of the water supply due to suction created by the Venturi effect.

In some embodiments, the shower-cleaning showerhead comprises a solenoid included in the diverter; and a power supply configured to provide current to the solenoid; wherein selectably preventing and allowing flow of water of the water supply to each of the shower face and the cleaning nozzle comprises providing current to the solenoid to cause a valve of the diverter to be opened or closed.

In some embodiments, the shower-cleaning showerhead comprises a backflow prevention device fluidly connected to the diverter and the cleaning nozzle, wherein the backflow prevention device is positioned between the diverter and the cleaning nozzle and is configured to prevent the flow of the mixture back toward the diverter.

In some embodiments, a shower-cleaning apparatus is provided, the shower-cleaning apparatus comprising: a diverter configured to be fluidly connected to a water supply the diverter having a first outlet and a second outlet; a showerhead face configured to be fluidly connected to the first outlet of the diverter; a cleaning nozzle configured to be fluidly connected to the second outlet of the diverter, wherein the cleaning nozzle is configured to be fluidly connected to a supply of a cleaning agent such that the cleaning agent mixes with water of the water supply to create a mixture that flows out of the cleaning nozzle; one or more processors; an input device configured to receive input from a user and send one or more signals to the one or more processors; and memory storing instructions executable by the one or more processors to cause the one or more processors to: detect an input received by the input device, wherein the input comprises an instruction to allow flow of water from the water supply to the cleaning nozzle and to disallow flow of water from the water supply to the showerhead face; and send a signal to the diverter, in response to detecting the input, configured to cause the diverter to allow flow of water from the water supply to the cleaning nozzle and to disallow flow of water from the water supply to the showerhead face.

In some embodiments of the shower-cleaning apparatus, the signal sent to the diverter is configured to cause current to be provided to a solenoid to cause a valve of the diverter to be opened or closed.

In some embodiments of the shower-cleaning apparatus, the input comprises an instruction for the showerhead to begin a cleaning cycle.

In some embodiments of the shower-cleaning apparatus, the input device comprises a button or knob.

In some embodiments of the shower-cleaning apparatus, the input device comprises a remote electronic device configured to transmit a wireless signal regarding the input to the one or more processors

In some embodiments, the shower-cleaning apparatus comprises an output device, wherein the instructions executable by the one or more processors to: in response to receiving the input, cause the output device to generate and output a warning signal to notify a user that the cleaning nozzle is being activated before flow of water to the cleaning nozzle is allowed.

### BRIEF DESCRIPTION OF THE DRAWINGS

The invention will now be described, by way of example only, with reference to the accompanying drawings, in which:

FIG. 1 shows a shower-cleaning system in accordance with some embodiments.

FIGS. 2A and 2B show a shower-cleaning showerhead in accordance with some embodiments.

FIGS. 3A and 3B show a shower-cleaning showerhead in accordance with some embodiments.

FIGS. 4A and 4B show a shower-cleaning showerhead in accordance with some embodiments.

FIGS. 5A and 5B show a shower-cleaning showerhead in accordance with some embodiments.

FIG. 6 shows a shower-cleaning showerhead in accordance with some embodiments.

FIGS. 7A and 7B show a shower-cleaning showerhead in accordance with some embodiments.

FIG. 8 shows a shower-cleaning system in accordance with some embodiments.

FIG. 9 shows a shower-cleaning system in accordance with some embodiments.

FIG. 10 shows a shower-cleaning system in accordance with some embodiments.

FIG. 11 shows a flowchart depicting a method of cleaning a shower in accordance with some embodiments.

FIG. 12 shows a computer in accordance with some embodiments.

FIG. 13 shows a multi-port diverter system in accordance with some embodiments.

FIGS. 14A, 14B, and 14C show different views of a quarter-turn connector mechanism in accordance with some embodiments.

FIGS. 15A and 15B show different views of a push-in connector mechanism in accordance with some embodiments.

FIGS. 16A-16E depict various views of shower-cleaning showerhead 1600, in accordance with some embodiments.

FIG. 17 depicts battery compartment 1700, in accordance with some embodiments.

FIG. 18 depicts cleaner pouch connection 1800, in accordance with some embodiments.

FIG. 19 depicts Venturi 1900, in accordance with some embodiments.

FIGS. 20A-20D depict various views of nozzle 2000, in accordance with some embodiments.

FIG. 21 depicts a rotating cleaning nozzle, in accordance with some embodiments

FIG. 22 depicts a rotating cleaning nozzle, in accordance with some embodiments.

### DETAILED DESCRIPTION OF THE INVENTION

Described herein are exemplary embodiments of shower-cleaning systems that may address the problems and shortcomings of known shower-enclosure-cleaning methods and systems described above, including the problems of tiresome and burdensome manual labor or the inefficiency and inconvenience of repeatedly refilling water tanks. As used herein, the term “shower enclosure” may refer to any stall, room, or other complete or partial enclosure including one or more showers and/or baths.

The shower-cleaning systems described herein may address these problems by integrating a shower-cleaning system into the plumbing of the shower system itself. By placing a diverter having two or more outlets in the flow path of the water between a shower wall and a shower face, water that would normally simply supply the shower face may be selectively diverted to a separate water output (e.g., a cleaning nozzle) of a shower-cleaning system. Furthermore, cleaning fluid, solution, or detergent may be integrated into the system such that it is automatically mixed with the water downstream of the diverter so that a cleaning nozzle of the shower-cleaning system may dispense both water and detergent. By controlling the diverter electronically, users may set cleaning cycles that proceed automatically and without further user intervention, such that time-consuming, tiresome manual labor is not required by a user to clean the a shower enclosure. Furthermore, by integrating the system into the plumbing of the shower itself, the user can supply the cleaning system with water simply by turning on the water supply to the shower (e.g., by turning a knob) rather than being required to tediously and repeatedly refill tanks or otherwise manually supply water to a cleaning system. Various embodiments of shower-cleaning systems are described below in detail with reference to the figures included herein.

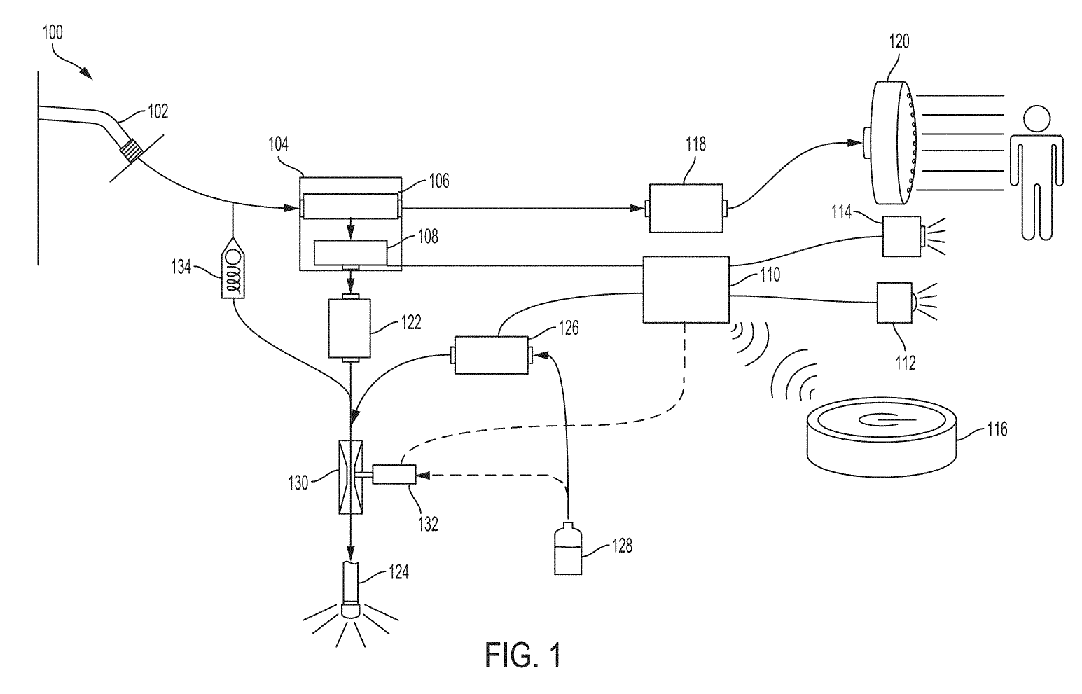

FIG. 1 shows a shower-cleaning system in accordance with some embodiments. Namely, FIG. 1 shows an exploded diagram of components of a shower-cleaning system 100 integrated into the plumbing of the shower system itself, such that various elements of shower-cleaning system 100 are fluidly connected to one another, such that water and/or other fluids may flow from one element to another as shown. As will be described further below, shower-cleaning system 100 may comprise multiple flow paths that may overlap in whole or in part and may further be implements in various embodiments with alternate or optional flow paths, as described herein.

In some embodiments, shower-cleaning system 100 comprises shower arm 102, which delivers mixed hot and cold water from the shower wall (shown at left of the shower arm) toward, and ultimately out of, shower face 120 and into the shower enclosure. Shower face 120, which is fluidly connected to shower arm 102, may be any showerhead, nozzle, sprayer, or other water outlet configured to spray, drip, or otherwise deliver water out of the plumbing system and onto the user in the shower enclosure. In a conventional shower system, shower arm 102 may connect and deliver water directly to shower face 120, and no intermediate components may be present in the shower system. As described below, shower-cleaning system 100 may include one or more intermediate components included in the system between shower arm 102 and shower face 120 that configure the shower-cleaning system to optionally divert water toward shower-cleaning components of shower-cleaning system 100.

In some embodiments, shower-cleaning system 100 comprises diverter 104, which may be a two-outlet and/or multi-outlet diverter positioned between, and fluidly connected to, shower arm 102 and shower face 120 and configured to selectably divert the flow of water away from shower face 120 and, instead, toward shower-cleaning components. In the example illustrated and in the description herein, diverter 104 may be referred to as a two-outlet diverter; however, it will be understood that a multi-outlet diverter or multi-outlet valve having three or more outlets could alternately or additionally be used. In some embodiments, one or more of the components of diverter 104 may be housed in a housing. In some embodiments, the housing may include any one or more additional components described with respect to FIG. 1, such as all elements of system 100 aside from shower face 120 and/or shower arm 102. In some embodiments, the housing may be water-tight such that water from the shower enclosure cannot enter the diverter housing. In some embodiments, the housing may be disposed along shower arm 102, such as at the junction of the wall and shower arm 102, at the junction of shower arm 102 and shower face 120, or at a position between the wall and shower face 120 but not touching either the wall or shower face 120. In some embodiments, the diverter 104 and/or a housing containing diverter 104 may be contained within or integrated into shower face 120 or a housing comprising shower face 120. Thus, in some embodiments, diverter 104 may not be visible to a user of the shower-cleaning system, and it may be spatially and visually unobtrusive by being integrated into a small housing that may optionally be contained in or be a part of other components of the system.

Diverter 104 may include valve 106, which may be a two-outlet valve fluidly connected to shower arm 102 and shower face 120 and configured to selectably divert the flow of water away from shower face 120 and, instead, toward shower-cleaning components. Valve 106 may be controlled by solenoid 108, such that current delivered to solenoid 108 may cause one of two outlets of valve 106 to be opened or closed in order to selectably direct the flow of water through one outlet or another of valve 106. In some embodiments, solenoid 108 may be a solenoid that controls one or more of the outlets of valve 106 directly, while in other embodiments solenoid 108 may control a one-outlet valve positioned adjacent to valve 106, such that opening and closing the adjacent one-outlet valve may selectably control the ability of water to flow out of one or more of the outlets of valve 106. In some embodiments, solenoid 108 (as well as other solenoids discussed herein) may draw electrical power from one or more batteries included in shower-cleaning system 100. In some embodiments, valves and/or diverters having more than two flow paths may optionally be used; thus, a two-outlet diverter may in some embodiments be replaced or supplemented with one or more diverters having two or more outlets.

In some embodiments, rather than a two-outlet diverter, a four-outlet diverter may instead be used. In some embodiments of a four-outlet diverter (or a diverter having more than four outlets), a respective one (or more) or the four (or more) outlets may correspond to the following: a high-flow outlet for cleaning via a cleaning nozzle, a high-flow outlet for rinsing via the cleaning nozzle, a low flow outlet (e.g., for a pause cycle) via the cleaning nozzle, and an outlet to the showerhead (rather than the cleaning nozzle).

In some embodiments, diverter 104 may include one or more flow sensors configured to detect and/or measure flow through one or more flow paths of diverter 104. In some embodiments, the flow sensor may be configured to generate one or more signals to be sent to a computing device such as computing element 110 (see below), such that one or more actions may be selectively taken in accordance with whether or not the flow sensor detects flow, and/or whether or not the flow sensor detects flow or a sufficient flow rate and/or sufficient water pressure. In some embodiments, alternately or in addition to a flow sensor, a pressure sensor may be used in diverter 104.

In some embodiments, a flow sensor and/or pressure sensor in diverter 104 may comprise a reed switch comprising elastic reeds and a magnet disposed in a water flow path and configured to be forced from a static position by the pressure of flowing water. When the magnet is forced from its static position, the magnet may be in effective proximity of the reeds, thereby causing the reeds to contact one another (or to break contact from one another) and to generate an electrical signal to be processed and used by the system.

In some embodiments, an electrical signal generated by a reed switch (or by another flow sensor and/or pressure sensor) may be used to direct power from the batteries or to control an input signal into a computing element (e.g., a PCB) of the system. In some embodiments, an input signal into a computing element of the system may allow one or more programs executed by the computing element to function according to a signal state, and may allow a satisfied condition to cause the system to execute one or more functions of the system (e.g., automatically controlling one or more valves, starting or stopping a mode or cycle, etc.).

In some embodiments, shower-cleaning system 100 comprises backflow prevention device 118, which may be positioned between diverter 104 and shower face 120 in a flow path, and fluidly connected to each. In some embodiments, the flow path from diverter 104 to shower face 120 may be a shower flow path separate from a cleaner flow path that flows separately from diverter 104. Water may thus flow through diverter 104, through backflow prevention device 118, and to and out of shower face 120. Backflow prevention device 118 may be any check-valve, vacuum breaker, or other device suitably configured to prevent flow of water backward from shower face 120 toward diverter 104, while allowing flow of water forwards from diverter 104 toward shower face 120. Backflow prevention device 118 may prevent cleaner from entering the potable water supply, and may prevent water from a shower enclosure from being drawn into the potable water supply (e.g., if the shower face is connected to a handheld showerhead that could be submerged in standing water in a bathtub).

In some embodiments, shower-cleaning system 100 comprises backflow prevention device 122, which may be fluidly connected to and positioned downstream from diverter 104 along a flow path for shower-cleaning components, as opposed to the flow path for shower-face components (including backflow prevention device 118 and shower face 120) discussed above. In some embodiments, the flow path for shower-cleaning components may terminate at cleaning nozzle 124, as discussed below. Like backflow prevention device 118, backflow prevention device 122 may be any valve or vacuum breaker, suitably configured to prevent flow of water backward toward diverter 104, while allowing flow of water forwards from diverter 104. Backflow prevention device 122 may prevent cleaner from flowing backward into the flow path for shower face 120, and may therefore prevent cleaner from flowing out of shower face 120 in some embodiments. Backflow prevention device 122 may prevent cleaner from entering the potable water supply, and may prevent water from a shower enclosure from being drawn into the potable water supply (e.g., if the shower face is connected to a handheld showerhead that could be submerged in standing water in a bathtub).

In some embodiments, shower-cleaning system 100 comprises cleaner 128 (which may alternately be referred to as detergent), which may be fluidly connected to the flow path terminating at cleaning nozzle 124, as discussed further below. In some embodiments, cleaner 128 may be any soap, detergent, chemical, solution, or cleaner configured to be used to clean a shower enclosure and/or shower system components. In some embodiments, cleaner 128 may comprise a bottle, bag, cartridge, or other container of liquid cleaning solution.

In some embodiments, cleaner 128 may be a concentrated cleaning solution or cleaning fluid configured to be mixed with water provided from the water source of a shower system and to accordingly be diluted to an appropriate concentration for shower-cleaning. Using a concentrated cleaner may be advantageous because it may decrease the burden in refilling or otherwise repeatedly providing larger volumes of diluted cleaning solution for shower-cleaning operations. For example, as opposed to spraying a shower enclosure directly with a handheld spray bottle of shower cleaner or as opposed to refilling a shower-cleaning system with a large tank of water, a user of shower-cleaning system 100 may simply need to periodically replace a small, lightweight bottle, cartridge, bag, or other container of concentrated cleaner, and the concentrated cleaner may be sufficient for 10 or more, 25 or more, or 100 or more cleaning cycles. Thus, concentrated cleaner configured to be automatically diluted from water provided by a shower system may substantially lower the physical burden on users cleaning showers and, further, may decrease the inconvenience of needing to perform frequent manual operations to apply cleaner directly or to refill or replace containers of dilute cleaner or water.

In some embodiments, cleaner 128 may comprise a bottle, bag, cartridge, or other container configured to be attached to one or more other components of shower-cleaning system 100. In some embodiments, a container of concentrated cleaning liquid may be configured to be inserted into an opening on a showerhead, shower face (e.g., shower face 120), shower arm (e.g., shower arm 102), housing of a diverter (e.g., diverter 104), or other component of a shower-cleaning system. For example, a container of cleaning liquid may have an opening, such as an opening at a top of a bottle or an opening joined to a bag, that is configured to be joined to an opening of a component of a shower-cleaning system. In some embodiments, the opening may have threads along an outer or inner edge such that the opening may be threaded onto and attached securely to the component. In some embodiments, other techniques may be used to attach the opening, including, but not limited to, mechanical attachment (clasps, buckles, snaps, clamps, etc.), suction, magnetic attachment, or any other suitable attachment device, system, or technique. In some embodiments, attachments systems and/or techniques may be configured to be effective in wet conditions as the cleaner container and the component to which it is attached may be located inside a shower enclosure. In some embodiments, attachment systems and/or techniques may be configured to allow simple and repeated attachment, detachment, and re-attachment such that a user may replace or refill the container as necessary.

In some embodiments, the container may be a bottle or bag containing cleaner liquid. In some embodiments, the container may have a round opening having threads configured to attach to a threaded opening on a component of the cleaning system such that the container may be screwed onto the cleaning system to attach into place in fluid connection with the attached component. In some embodiments, the container may be configured to attach to shower-cleaning system 100 such that the opening faces downward and such that gravity may cause the liquid in the container to flow out of the container. In some embodiments, such as those in which the container is configured to attach to shower-cleaning system 100 such that the opening on the container is not facing downward, other techniques may be used to cause flow of liquid out of the container. For example, as described further below, suction may be created to create flow of liquid out of the container; in some embodiments, suction may applied via a pump powered by electrical power and/or by a Venturi pump system creating suction due to the flow of water through the shower-cleaning system. Both of these embodiments will be discussed in further detail below.

In some embodiments, the container of cleaner 128 may be partially or substantially inflexible, such as when the container is a bottle. In some such embodiments, an air outlet may be included in the container such that, as suction is applied to the container or as gravity operates to move liquid out of the container, the container may refill with air as the liquid exits. For example, a second opening may be provided in the container to allow air to enter the container; the second opening may be configured or positioned such that liquid may not flow out of it. In some embodiments, the second opening may be configured to be closed until the container is attached to the attaching component of shower-cleaning system 100, at which time the opening may be automatically opened, such as by being punctured or pressed into an open position by the force applied by the user in attaching the container (e.g., the second opening may be covered by foil or plastic that is punctured when the container is placed into the attached positon). In some embodiments, the primary opening of the container (e.g., the opening configured to allow liquid to flow out of the container, may similarly (e.g., additionally or alternatively) be configured to be closed or sealed before attachment and to be automatically opened when the container is attached.

In some embodiments, rather than being configured to be able to fill with air as liquid exits the container, the container may be configured as a substantially flexible and collapsible bag such that the container may under the suction force applied to it so that it has substantially no volume when completely collapsed under the section force (e.g., less than 20%, less than 10%, less than 5%, less than 2%, or less than 1% of the volume when full). In these embodiments, there may be no need to allow the container to fill with air. In some such embodiments, the container may be a plastic bag, which may optionally be contained inside a substantially inflexible outer container (e.g., bottle or cartridge).

In some embodiments, in order to allow for liquid to be drawn from the container when the opening is positioned at the top of the container (e.g., when liquid is drawn from the container by suction rather than by gravity), a straw or other tube may be positioned inside the container in order to allow a suction force to be applied to the bottom of the container and to draw liquid upward from the bottom of the container, even when an upper portion of the container adjacent to the opening is filled only with air. In some embodiments, the straw may be an integrated part of the container itself, such as a straw attached to the underside of a cap of the container, configured such that the opening at the top of the straw may be punctured or otherwise opened when the container is attached to a component of shower-cleaning system 100. In some embodiments, the straw may be a part of the component of shower-cleaning system 100 to which the container attaches, such that the container opening slides around the straw as the container is attached to the component.

In some embodiments, cleaner 128 may be fluidly connected to pump 126, which may be downstream from cleaner 128 and may join cleaner 128 to the flow path terminating at cleaning nozzle 124. In some embodiments, pump 126 may be powered by electrical power and may be configured to apply suction force to draw in liquid from cleaner 128 and to output the liquid toward and/or into the flow path terminating at cleaning nozzle 124. In some embodiments, pump 126 may draw electrical power from one or more batteries included in shower-cleaning system 100. In some embodiments, pump 126 may pump cleaner at a predetermined rate, while in other embodiments the rate at which pump 126 pumps cleaner varies in accordance with a flow rate or the pressure of the water flowing through system 100. Upon being drawn into the flow of water, the liquid of cleaner 128 may be mixed into and diluted in the water flow before flowing to and being output by cleaning nozzle 124. In some embodiments, alternately or in addition to the arrangement including pump 126 described above, cleaner 128 may be fluidly connected to Venturi 130, which may be downstream from cleaner 128 and may join cleaner 128 to the flow path terminating at cleaning nozzle 124. In some embodiments, Venturi 130 may be any valve configured to create suction due to the Venturi effect. In some embodiments, Venturi 130 may be positioned in the flow path between backflow prevention device 122 and cleaning nozzle 124 such that a primary flow of water may flow through Venturi 130 from backflow prevention device 122 to cleaning nozzle 124 and such that the flow of water may create a pressure difference that applies suction to an inlet that is fluidly connected to cleaner 128 such that cleaner 128 is drawn into the primary flow of water by the suction force. Upon being drawn into the flow of water, the liquid of cleaner 128 may be mixed into and diluted in the water flow before flowing to and being output by cleaning nozzle 124.

In some embodiments, Venturi 130 may be controlled by and/or positioned adjacent to solenoid 132 such that current delivered to solenoid 132 may cause the inlet of Venturi 130 to be selectably opened and closed so that cleaner may flow to or be blocked from flowing to the inlet. In some embodiments, solenoid 132 may be integrated into the inlet directly, while in other embodiments solenoid 108 may control a valve positioned adjacent to the inlet such that opening and closing the adjacent valve may selectably control the ability of cleaner to flow into the inlet.

In some embodiments, a user may inject cleaner 128 into the system via one or more primer bulbs. For example, a user may create pressure and/or suction by pressing a primer bulb, and the pressure or suction may cause cleaner 128 to flow toward and/or into the flow path terminating at cleaning nozzle 124.

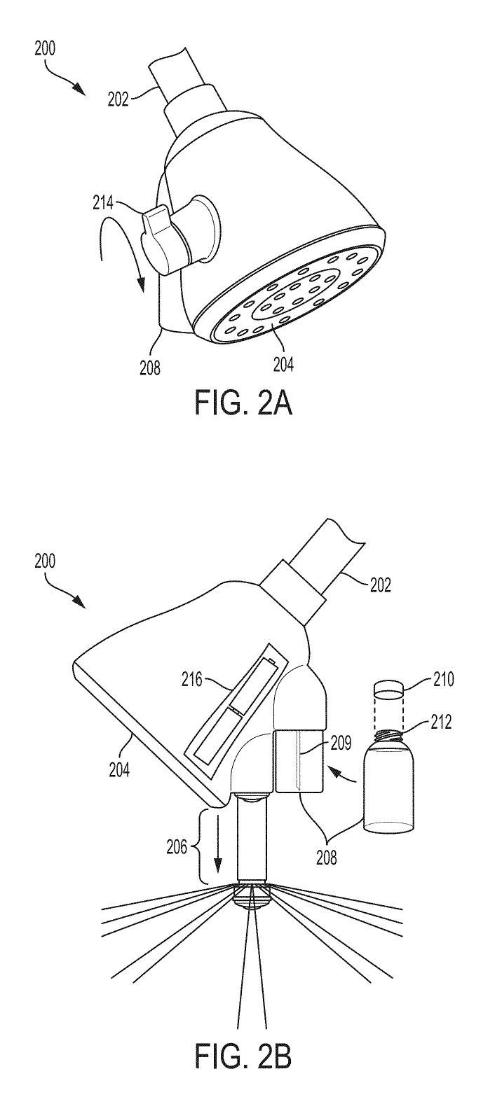

In some embodiments, shower-cleaning system 100 comprises cleaning nozzle 124. Cleaning nozzle 124 may be fluidly connected downstream along the flow path from backflow prevention device 122 and cleaner 128, and it may be any showerhead, nozzle, sprayer, or other water outlet configured to spray, drip or otherwise deliver water and cleaner liquid out of the plumbing system and onto the user in the shower enclosure. In some embodiments, cleaning nozzle 124 may be a sprayer nozzle configured to spray cleaning solution and/or water onto the shower enclosure for the purpose of cleaning the shower enclosure. In some embodiments, cleaning nozzle 124 may be disposed on a component of shower face 120, such as a showerhead, and may be configured to spray water and cleaner from a showerhead in a same direction or a different direction as shower face 120 sprays water. In some embodiments, cleaning nozzle 124 may be disposed on an opposite side of a showerhead as shower face 120, while in some embodiments cleaning nozzle 124 may be integrated into shower face 120. Cleaning nozzle 124 may be flush with a showerhead and/or shower face 120 or it may extend outward from either. Arrangements in some embodiments will be further described below with respect to FIGS. 2-7.

In some embodiments, cleaning nozzle 124 may be a pop-up nozzle configured to be extended outward from a first position by water pressure into a second position and then to retract to the first position by a spring force when the water pressure is removed.

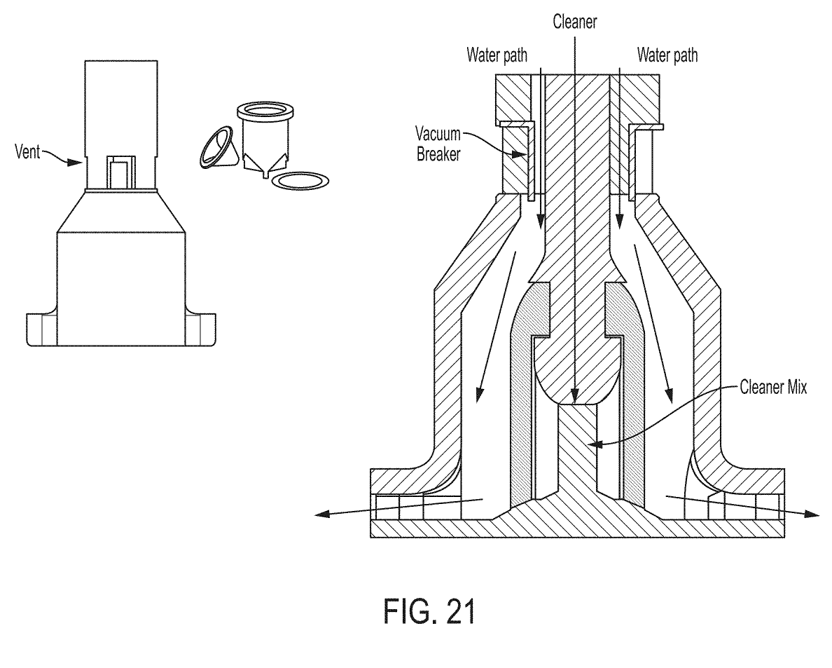

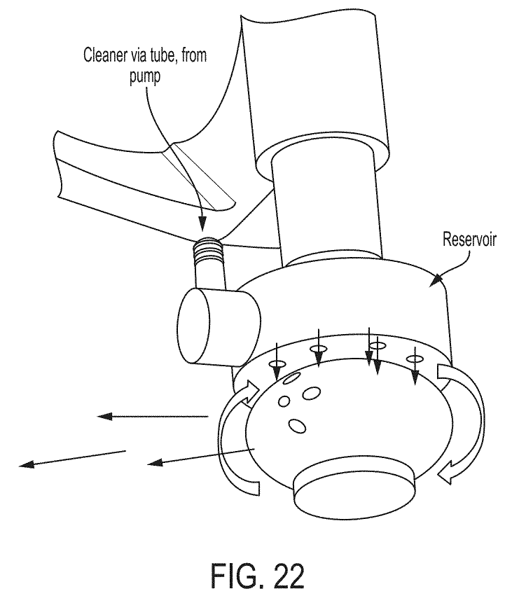

In some embodiments, the cleaning nozzle may be configured to rotate, wobble, spin, sweep, or otherwise move without manual intervention in order to enable effectively spraying a larger surface of the shower enclosure. For examples of cleaning nozzles configured to rotate, see FIGS. 21 and 22, discussed below. In some embodiments, cleaning nozzle 124 may be configured to spray water at a higher speed and/or with greater force than shower face 120 in order to enable effective cleaning of the shower enclosure.

In some embodiments, shower-cleaning system 100 includes computing element 110. Computing element 110 may include any computer processor, such as a microchip, and may include any computer memory storing instructions executable by the microchip. Computing element 110 may include input means for receipt of instructions or inputs and may include output means to send signals or outputs. In some embodiments, computing element 110 may be configured to send control signals to one or more elements of shower-cleaning system 100 to control one or more functions of those elements. For example, computing element 110 may be electronically coupled to solenoids, multiway valves, multiport diverters, and/or pumps included in shower-cleaning system 100 to control the operation of said pumps or the delivery of current to said solenoids.

In some embodiments, computing element 110 is coupled to diverter 104 and/or solenoid 108 to control one or more components of diverter 104 and/or the current provided to solenoid 108 and to thereby control the flow of water through valve 106 and diverter 104. In some embodiments, diverter 104 may contain one or more solenoids, one or more multiway valves, and/or one or more multiport diverters, any or all of which may be controllable by computing element 110 to control the flow of water through diverter 104. For example, computing element 110 may cause solenoid 108 to open or close an associated valve (e.g., valve 106) to direct water along the first flow path toward shower face 120 when shower-cleaning system 100 is in shower mode, and computing element 110 may cause solenoid 108 to open or close an associated valve (e.g., vale 106) to direct water along the second flow path toward cleaning nozzle 124 when shower-cleaning system 100 is in cleaning mode (or an associated rinse mode). In some embodiments, diverter 104 may contain one or more gear motors configured to control flow of water through diverter 104, and the one or more gear motors may be controlled via electrical signals received from computing element 110.

In some embodiments, computing element 110 is coupled to solenoid 132 to control the flow of cleaning fluid or solution into Venturi 130. For example, computing element 110 may cause solenoid 132 to open or close an associated valve (e.g., a valve of Venturi 130) to allow the flow of cleaning fluid into Venturi 130 when shower-cleaning system 100 is in a cleaning mode, and computing element 110 may cause solenoid 132 to open or close an associated valve (e.g., a valve of Venturi 130) to disallow the flow of cleaning fluid into Venturi 130 when shower-cleaning system 100 is in a shower mode or a rinse mode. (In some embodiments, in a rinse mode, water may flow along the second flow path from diverter 104 toward and out of cleaning nozzle 124, but cleaning fluid may not be inserted into the flow path such that only water exits cleaning nozzle 124.

In some embodiments, computing element 110 is coupled to pump 126 to control the power to and/or the functioning of pump 126 and to thereby control the flow of cleaning fluid or solution through pump 126 and into the second flow path from diverter 104 toward and out of cleaning nozzle 124. In a similar manner as discussed above with respect to computing element 110 controlling solenoid 132, computing element 110 may control pump 126 such that cleaning fluid is pumped into the flow path during a cleaning mode, but is not pumped into the flow path during a shower mode or during a rinse mode.

In some embodiments, shower-cleaning system 100 comprises speaker 114, which may be any audio magnetic indicator or auditory output mechanism coupled to computing element 110 and configured to output an audible signal to alert a user to a state of shower-cleaning system 100 such as the start or end of a shower mode, cleaning mode, rinse mode, or cleaning cycle (e.g., a cleaning cycle may include a cleaning mode and a rinse mode). In some embodiments, speaker 114 may further output an audible signal to indicate to a user that system 100 is in a ready state, that system 100 is not in a ready state, the batteries of system 100 are adequately charged, that batteries of system 100 are not adequately charged, that the water supply to the shower system is turned on, that the water supply to the shower system is turned off, or to indicate any other information about a state of shower-cleaning system 100 or an associated shower system. In some embodiments, alternative or additional output devices configured to output audible, visible, haptic, and/or tactile feedback may be used for similar purposes in similar manners.

In some embodiments, shower-cleaning system 100 comprises display 112, coupled to computing element 110, which may be visual output mechanism, including a display screen, monitor, touch-screen display, light, or LED. In some embodiments, display 112 may be configured to provide visual signals and/or alerts that serve any one or more of the purposes or indicate any one or more of the states and/or events discussed above with respect to speaker 114. In some embodiments, alternative or additional output devices configured to output audible, visible, haptic, and/or tactile feedback may be used for similar purposes in similar manners.

In some embodiments, shower-cleaning system 100 comprises input device 116. Input device 116 may be any button, switch, knob, dial, or sensor configured to receive input from a user and to transmit the input to computing element 110. Input received may direct system 100 to begin, pause, end, extend, shorten, or otherwise modify a shower mode, cleaning mode, rinse mode, and/or cleaning cycle. In some embodiments, input device 116 may be in electrical communication with computing element 110, such as when input device 116 is a button, knob, or switch integrated into a component of a shower system such as a showerhead. In some embodiments, input device 116 may be a remote device, such as a dedicated remote control or an electronic device having an application or program thereon, wherein the remote device is configured to communicate with computing element 110 via Radio Frequency, Infrared, Bluetooth, WiFi, or any one or more other suitable network communication channels.

In some embodiments, computing element 110 comprises a micro-switch and/or a Hall sensor. In some embodiments, a micro-switch and/or a hall sensor may be used to determine a position and/or orientation of one or more components of shower-cleaning system 100, such as a physical switch, knob, or diverter gear. In some embodiments, a micro-switch may be used to communicate a position of the one or more components to computing element 110, for example during a clean cycle or other cycle of the system. In some embodiments, the micro-switch may be unable to detect an absolute “home” position of the one or more components, so a Hall sensor may additionally be used to communicate detection of an absolute home position to computing element 110. For example, in some embodiments, the absolute “home” position may correspond to a showerhead setting of a diverter.

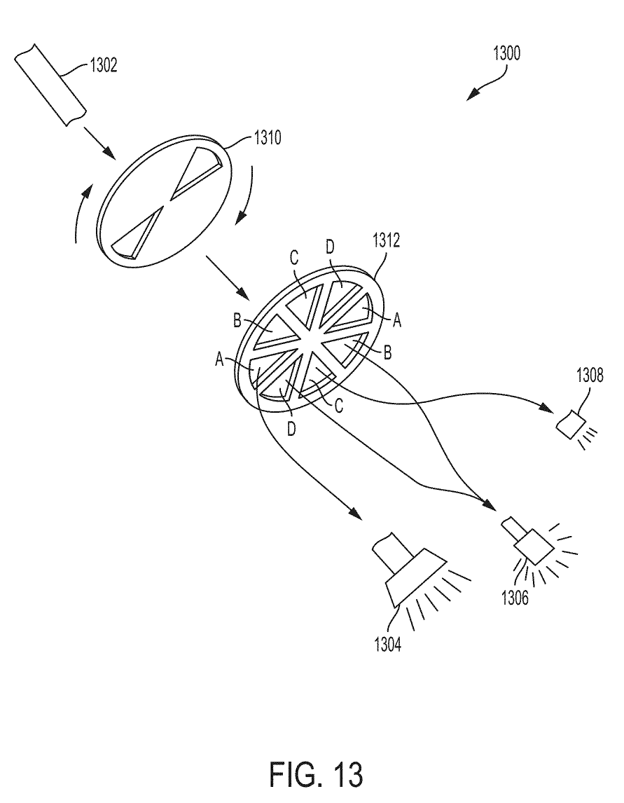

In some embodiments, shower-cleaning system 100 comprises pressure outlet 134, which may be a pressure outlet in fluid communication with shower arm 102 and diverter 104. Pressure outlet 134 may be located upstream from diverter 104. In some embodiments, pressure outlet 134 may enable the output of water from shower arm 102, such as by dripping water into the shower enclosure, when one or more other elements of shower-cleaning system 100 disables the output of water from one or more output points of shower-cleaning system 100 (e.g., shower face 120 or cleaning nozzle 124). In some embodiments, pressure outlet 134 may ensure compliance with regulatory requirements that may require a pressure outlet when closable valves are placed in a flow path of a shower system. In some embodiments, pressure outlet 134 may be configured to allow water to bypass diverter 104 and flow to shower face 120. In some embodiments, pressure outlet 134 may be a port that allows a small amount of water to flow out of a shower face or an alternative port. In some embodiments, pressure outlet 134 may be a dedicated port in a diverter system such as diverter 104, wherein the dedicated port may allow water to flow out of a port and/or outlet into a shower enclosure area (such as shown in FIG. 13).

Below, FIGS. 2-7 demonstrate certain embodiments of shower-cleaning showerheads that may be included, in some embodiments, in shower-cleaning system 100. In some embodiments, a shower-cleaning showerhead may contain any one or more of the elements discussed above with respect to shower-cleaning system 100.

FIGS. 2A and 2B show two views of shower-cleaning showerhead 200 in accordance with some embodiments. Shower-cleaning showerhead 200 may be included in shower-cleaning system 100 as discussed above, and it may comprise any one or more of the elements of shower-cleaning system 100 discussed above. In FIG. 2A, shower-cleaning showerhead 200 is in a shower mode with cleaning nozzle 206 retracted; in FIG. 2B shower-cleaning showerhead 200 is in a cleaning or rinse mode with cleaning nozzle 206 extended.

In some embodiments, shower-cleaning showerhead 200 comprises shower arm 202, which may share some or all of the properties of shower arm 102 as discussed above with reference to FIG. 1.

In some embodiments, shower-cleaning showerhead 200 comprises shower face 204, which may share some or all of the properties of shower face 120 as discussed above with reference to FIG. 1.

In some embodiments, shower-cleaning showerhead 200 comprises cleaning nozzle 206, which may share some or all of the properties of cleaning nozzle 124 as discussed above with reference to FIG. 1. As shown in the example of FIG. 2B, cleaning nozzle 206 may, in some embodiments, include a sprinkler-head style nozzle, such as a Rain Bird style (e.g., multistream rotary nozzle type), Hunter style, K Rain style, Signature style, Toro style, Irritrol style, Aqualine style, Champion style, Hydro-Rain style, or Weathermatic style sprinkler head. In some embodiments, cleaning nozzle 206 may be configured to rotate, be fixed, oscillate, and/or spiral. In some embodiments, cleaning nozzle 206 may be configured to automatically extend downward from showerhead 200 under the force of water pressure supplied by the shower system to cleaning nozzle 206; cleaning nozzle 206 may retract back upwards into showerhead 200 under a spring force when the water pressure is cut off.

In some embodiments, shower-cleaning showerhead 200 comprises cleaner bottle 208, which may share some or all of the properties of cleaner 128 and a container therefor as described above with respect to FIG. 1. As shown in the example of FIG. 2B, cleaner bottle 208 may, in some embodiments, comprise threading 212 around an opening of cleaner bottle 208, and it may comprise cap 210 configured to cover the opening. In some embodiments, cap 210 may attach to cleaner bottle 208 via threading 212; in some embodiments, when cap 210 is removed from cleaner bottle 208, threading 212 may then be used to connect cleaner bottle 208 to showerhead 200 by screwing the threads into corresponding receiving threads on showerhead 200. In some embodiments, threading may be provided that may be used to attach bottle 208 to showerhead 200 without the need to remove a cap first; in some such embodiments, the threads may be externally located on bottle 208 around an opening or neck of bottle 208, and an opening of bottle 208 may be automatically punctured or otherwise opened when bottle 208 is connected to showerhead 200. In some embodiments, bottle 208 may be connected to shower-cleaning showerhead 200 by a quarter-turn connector and/or by a push-in connector.

In some embodiments, shower-cleaning showerhead 200 comprises straw 209, which may share some or all of the properties of straws associated with cleaner 128 as described above with respect to FIG. 1. In some embodiments, straw 209 extends downward from showerhead 200 and into bottle 208, connecting at its top end to showerhead 200 and terminating at its bottom (distal) end near or at the bottom of bottle 208. Straw 209 may enable suction force applied by showerhead 200 to be transferred to the bottom of bottle 208 such that cleaning fluid may be drawn out of the bottom of bottle 208. In some embodiments, straw 209 may be an integrated component of bottle 208 such that each replacement bottle for a shower-cleaning system comes with a new straw. This may make showerhead 200 less obtrusive when bottle 208 is removed from it, since straw 209 will not be extending from showerhead 209. In alternate embodiments, however, straw 209 may be permanently connected to showerhead 200 such that bottle 208 may be fitted around stray 209 when it is connected to showerhead 200; these embodiments may have the advantage that the weight and cost of replacement bottles may be decreased if each bottle does not include its own integrated straw.

In some embodiments, shower-cleaning showerhead 200 comprises knob 214, which may share some or all of the characteristics of input device 116 as described above with reference to FIG. 1. In some embodiments, knob 214 may be used by a user to select one or more setting of more for shower-cleaning showerhead 200, such as selecting to start or end a cycle; setting showerhead 200 to a specific mode or to a specific cycle; or extending, shortening, pausing, resuming, or otherwise modifying one or more states, modes, or cycles of shower-cleaning showerhead 200. For example, a user may turn knob 214 to a “shower mode” setting, a “cleaning mode” setting, or a “rinse mode” setting, in some embodiments. In some embodiments, knob 214 may be configured to automatically return to a default position (e.g., “shower mode”) after a predetermined amount of time, such as when a cleaning cycle is completed. In some embodiments, knob 214 may gradually return to a default position, after being actuated, due to a spring force that gradually forces it into its default position.

In some embodiments, knob 214 may be an electronic control mechanism that communicates electronically with processing elements of showerhead 200 to control one or more functionalities of showerhead 214. In some embodiments, knob 214 may be a mechanical knob that physically actuates one or more valves in order to cause selection of shower mode, cleaning mode, or rinse mode. In some embodiments in which knob 214 is a mechanical knob, knob 214 may comprise a physical connection to one or more valves or ports of a diverter such as diverter 104, and knob 214 may allow a user to directly control the a multi-outlet diverter and/or associated valve, with or without electricity. In instances in which diverter 104 is generally controlled by electronic controls, knob 214 may serve as a backup control mechanism that allows a user to control the flow of water through a diverter if the electronic controls are unavailable (e.g., batteries are dead) or malfunctioning, thereby ensuring that a user may always be able to access various modes by manually turning the knob to access the various modes, including shower mode, cleaning mode, rinse mode, and/or a bypass mode that may be associated with a pause period between a cleaning mode and a rinse mode. Thus, in some embodiments, knob 214 may be included in a showerhead alongside separate electronic controls, and knob 214 may be used as an alternative control mechanism that may bypass the electronic control system to directly and manually control the flow of water. In some embodiments, access to knob 214 may be shown on the exterior of the shower head body. In some embodiments, access to knob 214 may be concealed via a hatch, within the showerhead body, yet user accessible without tools.

In some embodiments, shower-cleaning showerhead 200 comprises battery door 216, which may conceal replaceable and/or rechargeable batteries that may provide power to one or more electrical components of showerhead 200. For example, the batteries concealed behind battery door 216 may provide power to diverters and/or solenoids of showerhead 200 and/or to processing components of showerhead 200. In some embodiments, battery door 216 may be flush with an external surface of showerhead 200 and may be watertight. In some embodiments, batteries used as part of a shower-cleaning system, such as any of the systems described herein, may be disposed inside a battery tray that may be configured to fit inside a housing of the system such that the batteries are operatively electrically connected to the system, such as behind door 216 of showerhead 200. In some embodiments, the tray may be configured to be able to be quickly removed by a user, such as by being releasable in accordance with a user pressing a button.

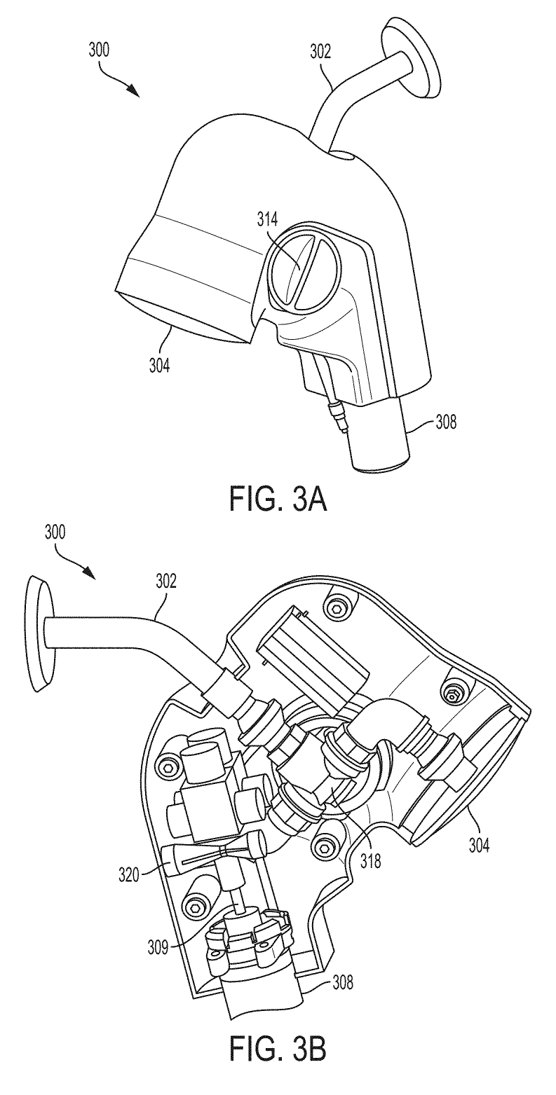

FIGS. 3A and 3B show two views of shower-cleaning showerhead 300 in accordance with some embodiments. Shower-cleaning showerhead 300 may be included in shower-cleaning system 100 as discussed above, and it may comprise any one or more of the elements of shower-cleaning system 100 discussed above. FIG. 3A is an external view of shower-cleaning showerhead 300, while FIG. 3B is a cross-sectional view of shower-cleaning showerhead 300.

In some embodiments, shower-cleaning showerhead 300 comprises shower arm 302, which may share some or all of the properties of shower arm 102 as discussed above with reference to FIG. 1.

In some embodiments, shower-cleaning showerhead 300 comprises shower face 304, which may share some or all of the properties of shower face 120 as discussed above with reference to FIG. 1.

In some embodiments, shower-cleaning showerhead 300 comprises a cleaning nozzle, which may share some or all of the properties of cleaning nozzle 124 as discussed above with reference to FIG. 1. In some embodiments, the cleaning nozzle may be disposed on a back side of showerhead 300, which may be an opposite side of showerhead 300 as the side on which shower face 304 is disposed.

In some embodiments, shower-cleaning showerhead 200 comprises cleaner bottle 208, which may share some or all of the properties of cleaner 128, and a container therefor as described above with respect to FIG. 1 or of cleaner bottle 208 as described above with reference to FIG. 2.

In some embodiments, shower-cleaning showerhead 300 comprises connector 309, which may share some or all of the properties of straw 209 as described above with reference to FIG. 2 and/or with straws associated with cleaner 128 as described above with respect to FIG. 1.

In some embodiments, shower-cleaning showerhead 300 comprises knob 314, which may share some or all of the characteristics of input device 116 as described above with reference to FIG. 1 and/or with knob 214 as described above with reference to FIG. 2.

In some embodiments, shower-cleaning showerhead 300 comprises diverter 318, which may share some or all of the properties of diverter 104 as described above with reference to FIG. 1. As shown in FIG. 3B, diverter 308 may be fluidly connected to shower arm 302, shower face 304, and cleaning nozzle 306. Diverter 308 may be configured to selectably divert water to one of shower face 304 or cleaning nozzle 306, or both. In a similar manner as described above with reference to FIG. 1, water may be directed to shower face 304 during a shower mode and may be directed to cleaning nozzle 306 during a cleaning mode and/or a rinse mode.

In some embodiments, shower-cleaning showerhead 300 includes Venturi 320, which may share some or all of the properties of Venturi 130 as described above with reference to FIG. 1. As shown in FIG. 3B, Venturi 320 may be fluidly connected to diverter 318 and cleaning nozzle 306, and it may be positioned between them. As water flows through Venturi 306 from diverter 318 toward cleaning nozzle 306, pressure may be created that draws cleaner fluid into the water flow from bottle 308, which may be fluidly connected to Venturi 320 (e.g., connected by connector 309).

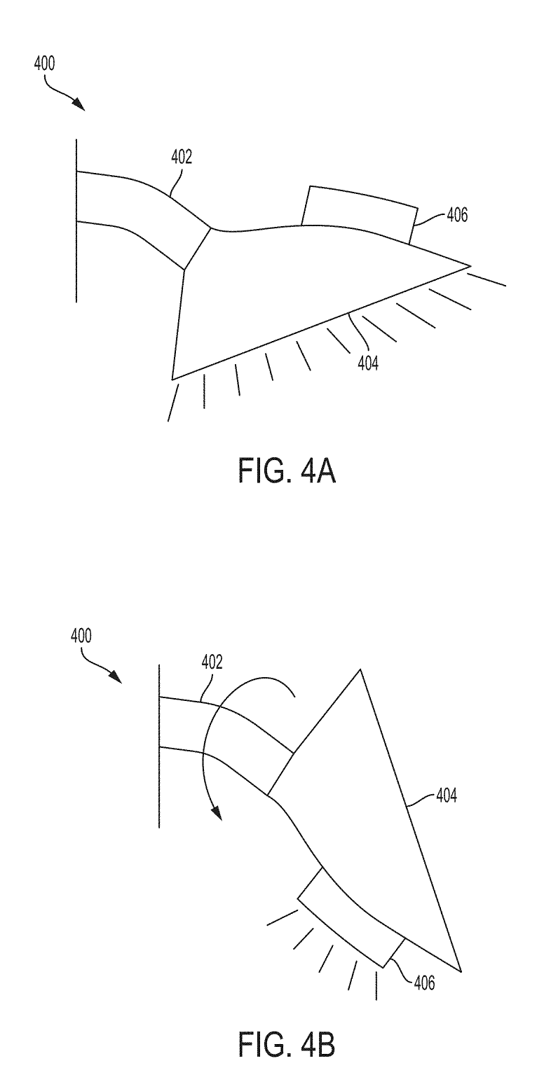

FIGS. 4A and 4B show two views of shower-cleaning showerhead 400 in accordance with some embodiments. Shower-cleaning showerhead 400 may be included in shower-cleaning system 100 as discussed above, and it may comprise any one or more of the elements of shower-cleaning system 100 discussed above. FIG. 4A shows shower-cleaning showerhead 400 in a shower mode, while FIG. 4B shows shower-cleaning showerhead 400 in a cleaning mode or rinse mode, with the showerhead rotatable 180 degrees about an axis of the shower arm to change between the modes.

In some embodiments, shower-cleaning showerhead 400 comprises shower arm 402, which may share some or all of the properties of shower arm 102 as discussed above with reference to FIG. 1.

In some embodiments, shower-cleaning showerhead 400 comprises shower face 404, which may share some or all of the properties of shower face 120 as discussed above with reference to FIG. 1.

In some embodiments, shower-cleaning showerhead 400 comprises cleaning nozzle 406, which may share some or all of the properties of cleaning nozzle 124 as discussed above with reference to FIG. 1. As shown in the example of FIG. 4B, cleaning nozzle 406 may be disposed on a top side of showerhead 300, which may be an opposite side of showerhead 400 as the side on which shower face 404 is disposed. In some embodiments, a user may rotate showerhead 400 about an axis of shower arm 402 in order to place showerhead 400 in cleaning mode or rinsing mode (as opposed to shower mode). In some embodiments, rotating showerhead 400 may cause physical actuation of a diverter and/or valve that directs the flow of water to either shower face 404 or cleaning nozzle 406. In some embodiments, by rotating showerhead 400 by 180 degrees from the position shown in FIG. 4A to the position shown in FIG. 4B, a user may actuate a valve or diverter internal to showerhead 400 in order to allow flow of water to cleaning nozzle 406 while simultaneously positioning showerhead 400 such that cleaning nozzle 406 is facing downward toward the shower enclosure to allow effective spraying/cleaning/rinsing of the shower enclosure by cleaning nozzle 406.

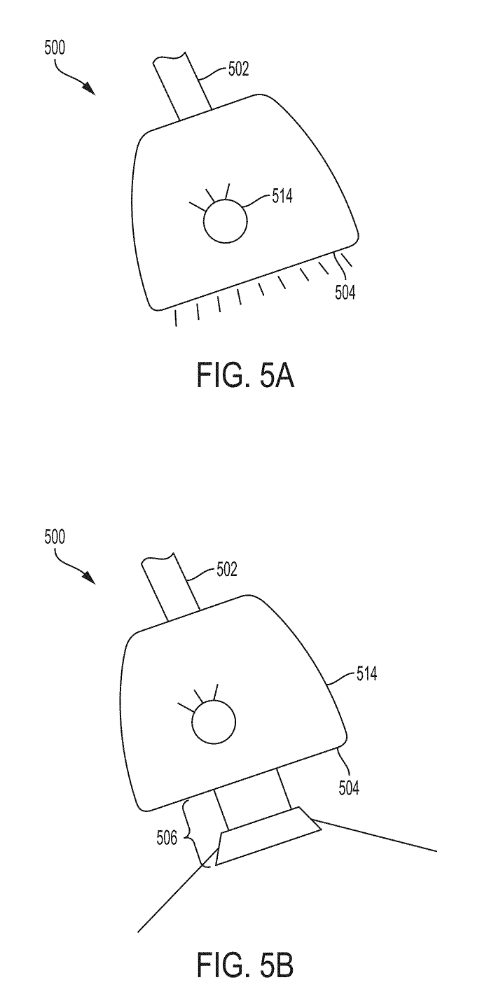

FIGS. 5A and 5B show two views of shower-cleaning showerhead 500 in accordance with some embodiments. Shower-cleaning showerhead 500 may be included in shower-cleaning system 100 as discussed above, and it may comprise any one or more of the elements of shower-cleaning system 100 discussed above. FIG. 5A shows shower-cleaning showerhead 400 in a shower mode with a cleaning nozzle retracted, while FIG. 5B shows shower-cleaning showerhead 400 in a cleaning mode or rinse mode with a cleaning nozzle extended outward from the shower face of the showerhead.

In some embodiments, shower-cleaning showerhead 500 comprises shower arm 502, which may share some or all of the properties of shower arm 102 as discussed above with reference to FIG. 1.

In some embodiments, shower-cleaning showerhead 500 comprises shower face 504, which may share some or all of the properties of shower face 120 as discussed above with reference to FIG. 1.

In some embodiments, shower-cleaning showerhead 500 comprises cleaning nozzle 506, which may share some or all of the properties of cleaning nozzle 124 as discussed above with reference to FIG. 1. As shown in the example of FIG. 5B, cleaning nozzle 506 may be disposed on shower face 504, such that cleaning nozzle 506 may be flush with shower face 504 when showerhead 500 is in shower mode (as shown in FIG. 5A) and may extend outward from shower face 504 when showerhead 500 is in cleaning mode or rinse mode. In some embodiments, cleaning nozzle 506 may be forced into the extended position shown in FIG. 5B by water pressure created by the flow of water delivered to cleaning nozzle 506 when the showerhead is in cleaning mode or rinse mode, and cleaning nozzle 506 may return to the retracted position shown in FIG. 5A under the force of a spring when water pressure to cleaning nozzle 506 is cut off (e.g., when showerhead 500 returns to shower mode). This arrangement, in which cleaning nozzle 506 is disposed directly on shower face 504, may be advantageous because a user may not be required to adjust a position of showerhead 500 in order to switch between shower mode and cleaning mode or rinse mode, thereby simplifying operation and reducing physical burden on the user.

In some embodiments, shower-cleaning showerhead 500 comprises knob 514, which may share some or all of the characteristics of input device 116 as described above with reference to FIG. 1. As shown in the example of FIG. 5A, knob 514 may, in some embodiments, have a plurality of settings to which it may be set. In some embodiments, each position may correspond to a predefined operation mode for showerhead 500 (e.g., shower mode, cleaning mode, rinse mode). In some embodiments, one or more positions may correspond to a different cleaning cycle that each comprise one or more modes; for example, in some embodiments, a “long cleaning” or “deep clean” cycle may include longer cleaning mode periods or rinse mode periods, and/or multiple cleaning mode periods or rinse mode periods, while a “short cleaning” or “quick clean” cycle may include shorter periods for certain mode and/or fewer periods for certain modes. In a similar manner as discussed above with respect to knob 214 in FIG. 2, knob 514 may in some embodiments automatically return to a default position (e.g., shower mode) as cleaning cycles complete or after a predefined amount of time.

In some embodiments, markings on or around knob 514 may provide a visual feedback to the user as to which mode or cycle showerhead 500 is currently set to. This may reduce the risk that a user is accidentally exposed to being sprayed by harsh cleaning chemicals during a cleaning mode. In some embodiments, other visual indications, such as those provided on a display or by a speaker associated with showerhead 500 and/or shower-cleaning system 100, may be provided.

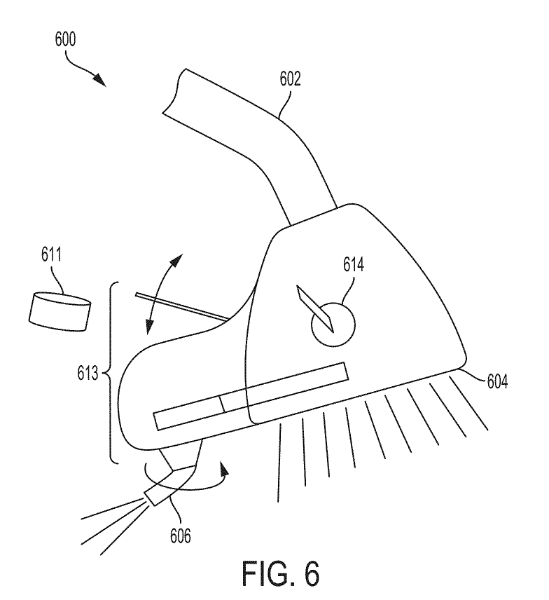

FIG. 6 shows shower-cleaning showerhead 600 in accordance with some embodiments. Shower-cleaning showerhead 600 may be included in shower-cleaning system 100 as discussed above, and it may comprise any one or more of the elements of shower-cleaning system 100 discussed above. As described below, showerhead 600 may be an embodiment in which a user may insert solid cleaner into a receiving part of showerhead rather than attaching a container of liquid cleaner as discussed above. For example, showerhead 600 may be configured to receive a solid tablet of cleaner, a gel tablet of cleaner, and/or powdered cleaner into a receiving part of showerhead 600, and the solid cleaner may then be mixed with water to create a dilute cleaning solution to be used by the system for cleaning a shower enclosure. In some embodiments, a tablet or other solid cleaner may be inserted once per cleaning cycle, once per a predetermined number of cleaning cycles, once per week, or once per month.

In some embodiments, shower-cleaning showerhead 600 comprises shower arm 602, which may share some or all of the properties of shower arm 102 as discussed above with reference to FIG. 1.

In some embodiments, shower-cleaning showerhead 600 comprises shower face 604, which may share some or all of the properties of shower face 120 as discussed above with reference to FIG. 1.

In some embodiments, shower-cleaning showerhead 600 comprises cleaning nozzle 606, which may share some or all of the properties of cleaning nozzle 124 as discussed above with reference to FIG. 1. As shown in the example of FIG. 6B, cleaning nozzle 606 may be disposed on a lower side of showerhead 600, which may be a same side of showerhead 600 as the side on which shower face 604 is disposed. In this arrangement, a user may not need to physically rotate, actuate, or otherwise manipulate showerhead 600 in order to place it into position for cleaning mode; that is, cleaning mode and rinse mode for showerhead 600 may take place when showerhead 600 is in the same position that it is in for shower mode. In some embodiments, cleaning nozzle 606 may automatically spin around an axis while it is spraying water and/or cleaner; in some embodiments, the spinning motion may be caused by the force of water pressure provided to cleaning nozzle 606. Spinning around an axis may ensure that cleaning nozzle 606 effectively cleans and rinses a large portion of the shower enclosure, as opposed to cleaning only a small portion with a stationary nozzle.

In some embodiments, showerhead 600 comprises cleaner receiver 613, which may be any receptacle, compartment, reservoir, or other container disposed on showerhead 600a and configured to receive cleaner. In some embodiments, cleaner receiver 613 may be a compartment with a hinged hatch over the top of the compartment, configured such that a user may open the hatch to insert cleaner into the compartment and then close the hatch while showerhead 600 executed a cleaning cycle. Cleaner receiver 613 may, in some embodiments, be fluidly connected to shower arm 602 and to cleaning nozzle 606 such that water may be directed from shower arm 602 through cleaner receiver 613 and to cleaning nozzle 606. In some embodiments, one or more walls of cleaner receiver 613 may be transparent or translucent so that a user may be able to visually see whether any cleaner is present inside cleaner receiver 613 without the need to open any doors, hatches, or caps.

In some embodiments, showerhead 600 may be configured to receive cleaner 611, which may be a dissolvable tablet, a dissolvable gel pod, powdered cleaner, gel cleaner, or any other solid tablet or portion of cleaner suitable to mix with water to form a diluted cleaning fluid. In some embodiments, cleaner 611 may be a liquid concentrate that is suitable to mix with water to form a diluted cleaning fluid. In some embodiments, a liquid concentrate included in cleaner 611 may be configured to be diluted by more than 10 parts water, more than 50 parts water, or more than 100 parts water to cleaner. In some embodiments, cleaner 611 may be configured to perform more than 5 cleanings, more than 10 cleanings, more than 25 cleanings, or more than 50 cleanings before cleaner 611 is exhausted and needs to be refilled/replaced. While passing through cleaner receiver 613, the water may be mixed with cleaner 611 when cleaner 611 has been inserted into cleaner receiver 613, and the water and cleaner 611 may create a diluted solution of cleaning fluid, which may flow out of cleaner receiver 613 and to cleaning nozzle 606.

In some embodiments, shower-cleaning showerhead 500 comprises knob 614, which may share some or all of the characteristics of input device 116 as described above with reference to FIG. 1, of knob 214 as described above with respect to FIG. 2, of knob 314 as described above with reference to FIG. 3, and/or of knob 514 as described above with reference to FIG. 5.

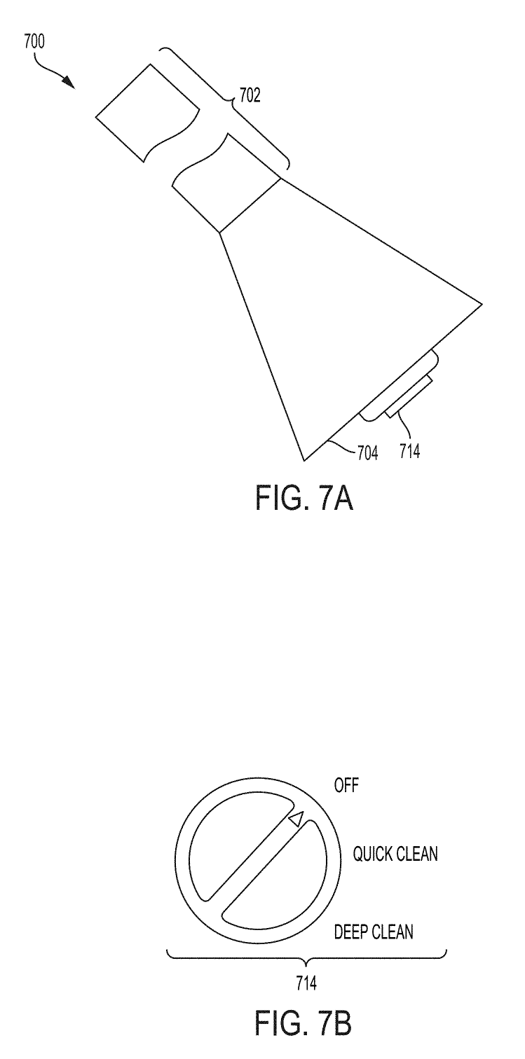

FIG. 7A shows shower-cleaning showerhead 700 in accordance with some embodiments, and FIG. 7B shows a highlight view of knob 714 in accordance with some embodiments.

Shower-cleaning showerhead 700 may be included in shower-cleaning system 100 as discussed above, and it may comprise any one or more of the elements of shower-cleaning system 100 discussed above. FIGS. 7A and 7B show an embodiment in which a knob for controlling a mode or cycle or a shower-cleaning showerhead is disposed on shower face of the showerhead.

In some embodiments, shower-cleaning showerhead 700 comprises shower arm 702, which may share some or all of the properties of shower arm 102 as discussed above with reference to FIG. 1.

In some embodiments, shower-cleaning showerhead 700 comprises shower face 704, which may share some or all of the properties of shower face 120 as discussed above with reference to FIG. 1.

In some embodiments, shower-cleaning showerhead 700 comprises knob 714, which may share some or all of the characteristics of input device 116 as described above with reference to FIG. 1 of knob 214 as described above with reference to FIG. 2, of knob 314 as described above with reference to FIG. 3, of knob 514 as described above with reference to FIG. 5, and/or of knob 614 as described above with reference to FIG. 6. As shown in FIG. 7A, knob 714 may, in some embodiments, be disposed directly on shower face 704. This arrangement may be advantageous because the position of knob 714 on shower face 704 may be easy to see and reach without unnecessary strain or movement by a user, as shower face 704 may usually be positioned to face into a shower enclosure and toward a location that is easily accessible by a user.

As shown in FIG. 7B, knob 714 may have a plurality of settings to which it may be set, including “off” (or “shower mode”), “quick clean,” and “deep clean.” These settings and modes may correspond to various functionalities of cleaning modes and rinse modes, for example as discussed above with respect to FIG. 5 and knob 514. In some embodiments, knob 714 may comprise a mechanical timer that gradually returns to a default “off” position as a cleaning cycle and/or rinse cycle is completed after a user twists knob 714 to “quick clean” or “deep clean.”

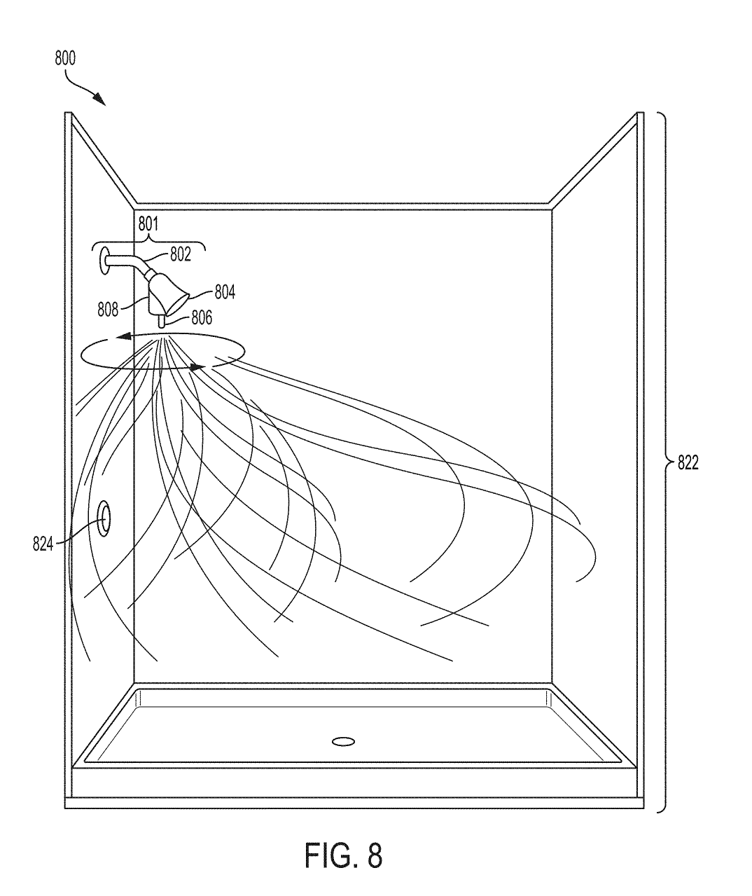

FIG. 8 shows shower-cleaning system 800 in accordance with some embodiments. Shower-cleaning system 800 may comprise any one or more of the elements of shower-cleaning system 100 discussed above with respect to FIG. 1.

Shower-cleaning system 800 may comprise shower-cleaning showerhead 801, which may share some or all of the characteristics of shower-cleaning showerhead 200, shower-cleaning showerhead 300, shower-cleaning showerhead 400, shower-cleaning showerhead 500, shower-cleaning showerhead 600, and/or shower-cleaning showerhead 700. Shower-cleaning system 800

Shower-cleaning system 804 may comprise shower arm 802, which may share some or all of the properties of shower arm 102 as discussed above with reference to FIG. 1.

Shower-cleaning showerhead 800 may comprise shower face 804, which may share some or all of the properties of shower face 120 as discussed above with reference to FIG. 1, shower face 204 as discussed above with reference to FIG. 2, shower face 304 as discussed above with reference to FIG. 3, shower face 404 as discussed above with reference to FIG. 4, shower face 504 as discussed above with reference to FIG. 5, shower face 604 as discussed above with reference to FIG. 6, and/or shower face 704 as discussed above with reference to FIG. 7.

Shower-cleaning system 800 may comprise cleaning nozzle 806, which may share some or all of the properties of cleaning nozzle 206 as described above with respect to FIG. 2, cleaning nozzle 306 as described above with respect to FIG. 3, cleaning nozzle 406 as described above with respect to FIG. 4, cleaning nozzle 506 as described above with respect to FIG. 5, and/or cleaning nozzle 606 as described above with respect to FIG. 6. As shown by the circular arrows in FIG. 8, cleaning nozzle 806 may in some embodiments rotate about one or more axis in order to spray a greater portion of a shower enclosure during cleaning cycles and/or rinse cycles.

Shower-cleaning system 800 may comprise shower enclosure 822, which may be any enclosure or partial enclosure defining a space in which a user may shower and/or bathe. A shower enclosure may include one or more floors, walls, ceilings, curtains, windows, glass panels, ceramic components, tile components, metal components, plumbing fixtures, lighting fixtures, electrical controls or fixtures, storage fixtures, handles, benches, or any other suitable component that may define or may be included in a shower space. Any or all of the components of shower fixture 822 may be cleaned by being sprayed and rinsed by cleaning nozzle 806.

Shower-cleaning system 800 may comprise water supply control 824, which may comprise one or more handles, knobs, levers, switches, buttons, electronic input devices, or any other suitable mechanical or electronic input device configured to control the flow of water to a shower-cleaning system 800. In some embodiments water supply control may be one or more conventional knobs or handles configured to control the supply of hot and/or cold water to a shower system; a shower-cleaning system such as shower-cleaning system 800 may be fluidly connected to the shower water supply and may be located downstream from water supply control (and/or any one or more valves controlled thereby), such as being located downstream from a shower arm such as shower arm 800. In some embodiments, in order to make use of a shower-cleaning system such a shower-cleaning system 800, a user must first ensure that water is supplied to the associated/integrated shower system itself, such as by turning on a water supply by using a water supply control such as water supply control 800.

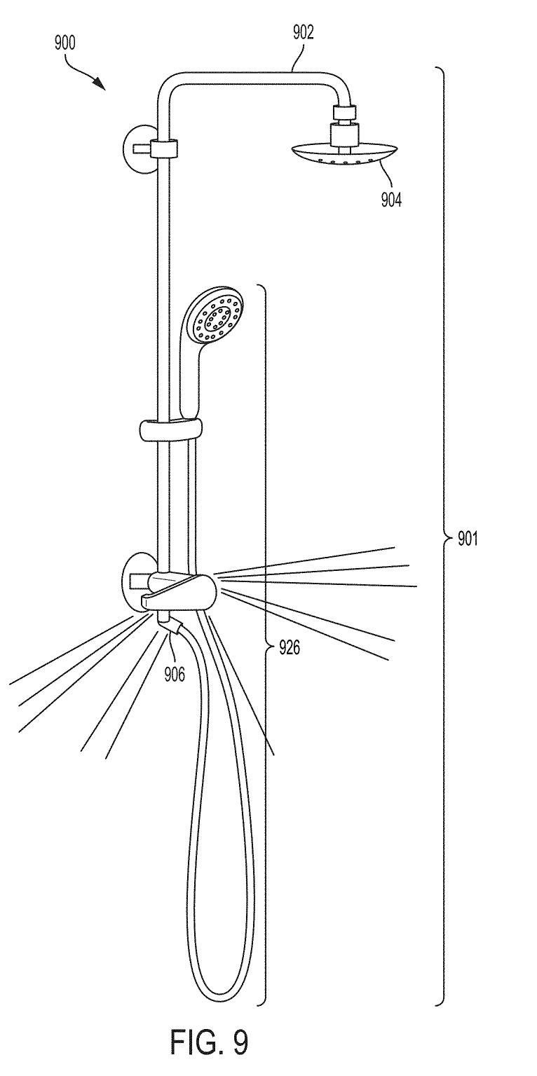

FIG. 9 shows shower-cleaning system 900 in accordance with some embodiments. Shower-cleaning system 900 may comprise any one or more of the elements of shower-cleaning system 100 discussed above with respect to FIG. 1 and/or shower-cleaning system 800 discussed above with respect to FIG. 8. As described below, rather than a showerhead-style arrangement, shower-cleaning system 900 comprises a shower-column-style arrangement comprising shower-cleaning retrofitted shower column 901.

In this arrangement, a shower column system comprises a vertical column fluidly connected to a shower arm and a shower face and also comprises a handheld washer. In some embodiments, both the shower face and handheld washer may be fluidly connected to the same shower water supply, but a user may be able to selectably divert the flow of water to one, the other, or both by use of one or more diverters and/or valves.

In some embodiments, shower-cleaning systems, such as those described with reference to FIG. 1 and elsewhere herein, may be implemented by placing a diverter, such as diverter 104, fluidly connected to and upstream from a diverter of a shower-column-style shower system such that a user first chooses whether to direct water to shower-cleaning components or to conventional shower components; then, when directing water to conventional shower components, the user may further choose whether to direct water to a shower face, such as shower face 904, or a handheld washer, such as handheld washer 926.

In some embodiments, shower-cleaning systems such as those described with reference to FIG. 1 and elsewhere herein may be implemented by placing a diverter, such as diverter 104, fluidly connected to and downstream from a diverter of a shower-column-style shower system, such that a user first chooses whether to direct water to a shower face, such as shower face 904, or a handheld washer, such as handheld washer 926; then, when directing water to one of the shower face or handheld washer that is fluidly connected to a shower-cleaning system, the user may choose whether to direct water to the shower-cleaning system by use of a diverter such as diverter 104.

In some embodiments, shower-cleaning systems such as those described with reference to FIG. 1 and elsewhere herein may be implemented by placing a three-way diverter in fluid connection with a water supply, shower-cleaning components, a shower face, and a handheld washer. A user may then use the three-way diverter to choose to direct water from the water supply to one or more of the shower-cleaning components, the shower face, or the handheld washer.

Shower-cleaning system 900 may comprise cleaning nozzle 906, which may share some or all of the properties of cleaning nozzle 206 as described above with respect to FIG. 2, cleaning nozzle 306 as described above with respect to FIG. 3, cleaning nozzle 406 as described above with respect to FIG. 4, cleaning nozzle 506 as described above with respect to FIG. 5, cleaning nozzle 606 as described above with respect to FIG. 6, and/or cleaning nozzle 806 described above with respect to FIG. 8. In some embodiments, cleaning nozzle 906 may be mounted on or near a water supply control or valve in a shower-column style shower-cleaning system such as shower-cleaning system 900.

In some embodiments, a shower-cleaning system including a handheld washer may not include a dedicated or fixed showerhead or shower face. In some such embodiments, only one diverter (to direct water either to a cleaning nozzle or to a handheld washer) may be necessary.

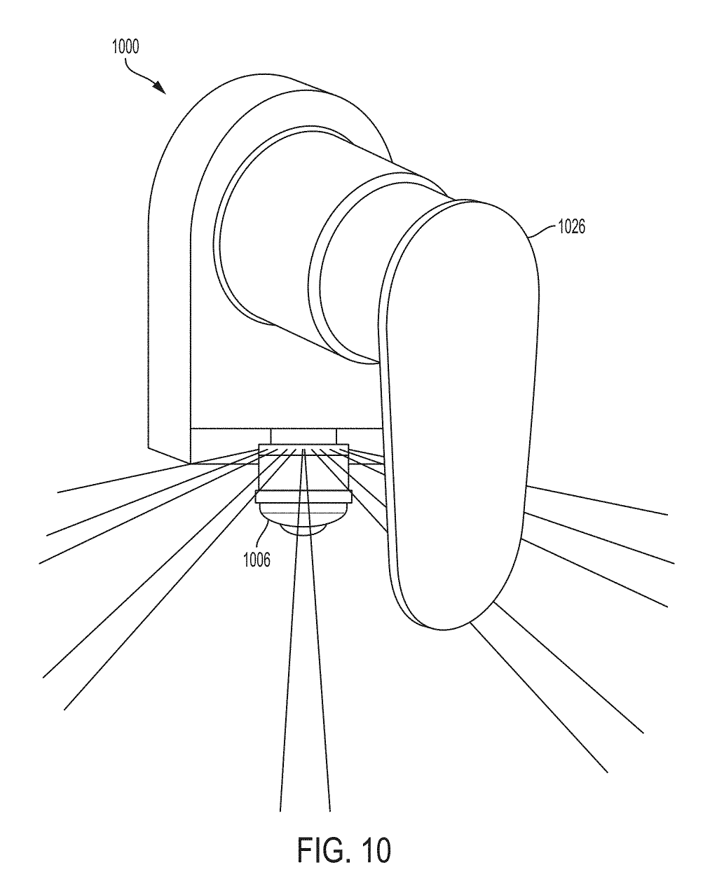

FIG. 10 shows shower-cleaning system 1000 in accordance with some embodiments. Shower-cleaning system 1000 may comprise water supply control 1026, which may share some or all of the properties of water supply control 824 described above with reference to FIG. 8. Shower-cleaning system 1000 may comprise cleaning nozzle 1006, which may share some or all of the properties of cleaning nozzle 206 as described above with respect to FIG. 2, cleaning nozzle 306 as described above with respect to FIG. 3, cleaning nozzle 406 as described above with respect to FIG. 4, cleaning nozzle 506 as described above with respect to FIG. 5, cleaning nozzle 606 as described above with respect to FIG. 6, cleaning nozzle 806 described above with respect to FIG. 8, and/or cleaning nozzle 906 described above with respect to FIG. 9.

Shower-cleaning system 1000 may comprise any one or more of the elements of shower-cleaning system 100 discussed above with respect to FIG. 1, shower-cleaning system 800 discussed above with respect to FIG. 8, and/or shower-cleaning system 900 discussed above with respect to FIG. 9.

The arrangement depicted in FIG. 10 may differ from other arrangements depicted herein in that one or more components described above with respect to FIGS. 1, 8, and/or 9 may be concealed behind a wall defining the shower enclosure, such that cleaning nozzle 1026 and water supply control 1024 may be located inside the shower enclosure while one or more other elements are not. For example, various diverters, backflow prevention devices, solenoids, computing elements, and associated electronics, pumps, Venturis, and cleaners may be wholly or partially concealed behind a shower wall on which water supply control 1024 and cleaning nozzle 1026 are mounted. This arrangement may be advantageous because it may be less obtrusive in the shower enclosure, and a user may be less likely to accidentally run into one or more of the shower-cleaning system components if they are concealed behind a wall of the shower enclosure.

In some embodiments, shower-cleaning system 1000 may comprise sprayer nozzle 1006 disposed on an interior of a shower enclosure, with sprayer nozzle 1006 fluidly connected to plumbing elements disposed behind a wall of the shower enclosure. In some embodiments, sprayer nozzle 1006 may be fluidly connected to a water supply and a water supply control (e.g., a valve) that may be independent of a water supply and water supply control of the shower itself. The water supply of cleaning nozzle 1006 may be connected to a cleaner supply as described above. Activation of this system such as system 1000 may be similar to the activation of other shower-cleaning systems described herein, with the exception that a user may not have to turn the shower valve on in order to supply flow of water to system 1000.

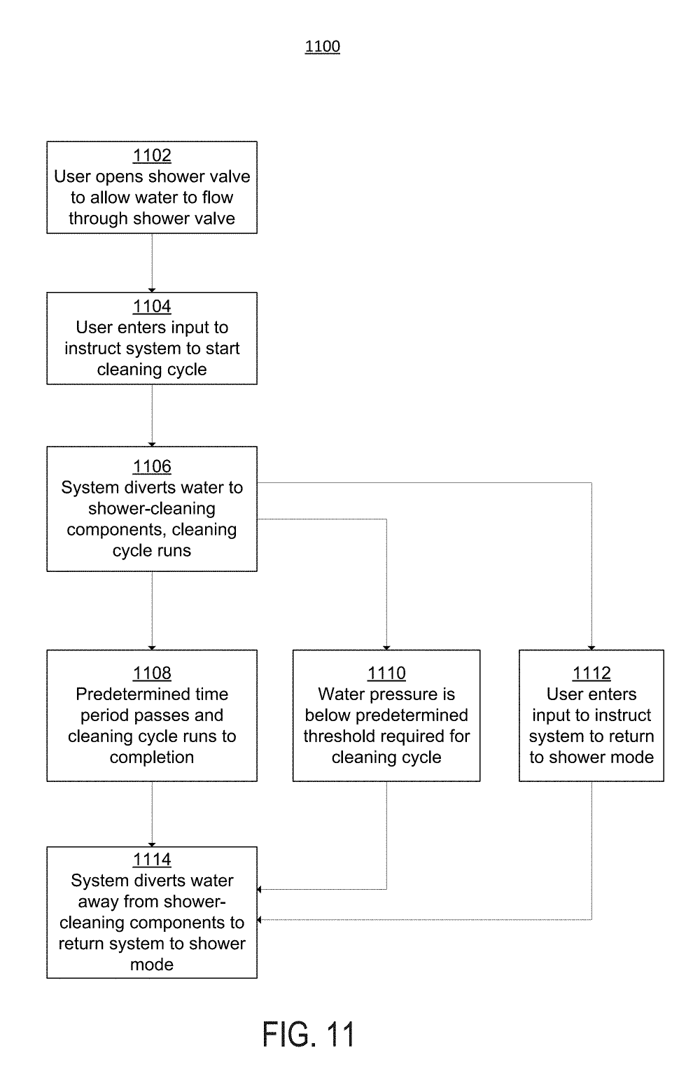

FIG. 11 shows a flowchart depicting method 1100 of cleaning a shower in accordance with some embodiments. In some embodiments, method 1100 may be carried out in whole or in part by any one of the shower-cleaning systems and/or components of shower-cleaning systems described above, such as by shower-cleaning system 100 as described with respect to FIG. 1.

At block 1102, in some embodiments, a user of a shower-cleaning system may open a shower valve to allow water to flow through the shower valve. For example, a user of shower-cleaning system 100 may turn a handle or knob to open one or more hot and/or cold water valves in order to cause water to flow to shower arm 102. In some embodiments, opening a shower valve may automatically cause water to be sprayed from a shower face of the shower-cleaning system such as shower face 120.

At block 1104, in some embodiments, a user may enter an input to instruct the shower-cleaning system to start a cleaning cycle. For example, entering an input may comprise actuating a physical knob, lever, handle, or switch; or it may comprise entering an electronic input such as by activating an electronic switch or button, or sending an electronic signal from a remote electronic control. In some embodiments, an electronic signal may be generated in accordance with the user entering an input, and a signal may be sent to a computing element of the shower-cleaning system. For example, a user may enter an input via input device 116 of FIG. 1, and a signal may be sent via, Radio Frequency (RF), Infared (IR), Bluetooth, WiFi, or direct electrical connection to computing element 110.

In some embodiments, responsive to the user input, a shower-cleaning system may emit or display one or more audible or visual alerts or signals before beginning a cleaning cycle, such as a warning signal intended to ensure that users are not accidentally present in a shower enclosure when a cleaning cycle begins. In some embodiments, a warning signal may occur at a predetermined amount of time, such as 5 seconds, 10 seconds, or 30 seconds, before a cleaning cycle begins.

In some embodiments, a shower-cleaning system may include a door sensor to sense a position of a door and/or an infrared sensor system to detect that the shower enclosure is secured and closed. In some embodiments, an infrared sensor may be configured to have a line of sight from the showerhead to a sticker, marker, reflective material, or other object that may be applied to or attached to a shower curtain, shower door, or other component of the shower enclosure. In some embodiments, the system may be configured to check, when the user enters an input to instruct the system to start a cleaning cycle, whether a shower enclosure is closed (e.g., door closed, curtain pulled, etc.), whether the shower enclosure is empty of persons, or whether the shower enclosure is otherwise in a suitable arrangement for the a cleaning cycle to proceed. In some embodiments, the system may only begin a cleaning cycle if a line of sight is clear and/or if one or more sensors confirm that the shower enclosure is closed and/or empty. In some embodiments, the system may be configured such that a cleaning cycle or cleaning mode may be activated only if one or more sensors confirm that no unidentified objects are present in the shower enclosure; the system may be configured such that, if one or more sensors detects an unidentified object in or near the shower enclosure, then the cleaning cycle and/or cleaning mode will not activate (or will cease if it has already begun).

At block 1106, in some embodiments, in response to the user entering the input to instruct the system to start a cleaning cycle, the system may divert shower-cleaning components such that a cleaning cycle may run. In some embodiments, diverting water to shower-cleaning components may include opening, closing, actuating, or otherwise manipulating one or more valves and/or diverters in order to cause water to flow along a flow path toward a cleaning nozzle and potentially to cause water to cease to flow along a flow path toward a shower face. In the example of system 100 in FIG. 1, computing element 110 may send a signal to diverter 104 (including any element included therein or associated therewith) and/or solenoid 108 that causes diverter 104 and/or valve 106 to redirect the flow of water from the flow path terminating at shower face 120 to the flow path terminating at cleaning nozzle 124. In some embodiments, rather than controlling a valve or diverter via electronic control, a diverter or valve may physically displaced or manipulated by a user's physical input.

In some embodiments, the flow of water may be directed in accordance with one or more predetermined cleaning cycles. In some embodiments, a cleaning cycle may be a pre-programmed or pre-configured series of operations executable by a shower-cleaning system that may include progressing through a time series of modes of operation including one or more periods in a cleaning mode and one or more periods in a rinse mode. In some embodiments, pauses or interludes may be included in a cleaning cycle, which may be advantageous because it may allow cleaner time to effectively remove dirt, mold, mildew, and water spots without prematurely rinsing the cleaner away. In some embodiments, a “cleaning mode” may refer to a mode of operation of a shower-cleaning system in which the flow of water is directed to a cleaning nozzle (rather than a shower face) and in which cleaner is mixed with the flow of water before the water is sprayed from the cleaning nozzle, thereby causing a dilute cleaning solution to be sprayed from the cleaning nozzle. In some embodiments, a “rinse mode” may refer to a mode of operation of a shower-cleaning system in which the flow of water is directed to a cleaning nozzle (rather than a shower face) and in which no cleaner (or, alternatively, a substantially decreased amount of cleaner) is mixed with the flow of water before the water is sprayed from the cleaning nozzle. In some embodiments, a variety of cleaning cycle programs may be stored in computer memory associated with computing elements of the shower-cleaning system, and the computing elements may access the stored cleaning cycle programs and execute one or more of them in accordance with a user selection.

In some embodiments, rather than causing computing elements to execute a stored program corresponding to a cleaning cycle, a user may simply turn a mechanical dial and/or timer through a predefined degree of rotation in order select a cleaning cycle. For example, a greater rotation may cause a longer period for a cleaning mode to be executed, corresponding to a “deep clean” cleaning cycle, while a lesser rotation may cause a shorter period for a cleaning mode to be executed, corresponding to a “quick clean” cleaning cycle.

Any one or more of blocks 1108, 1110, and 1112 may optionally follow, in some embodiments, from block 1106.

At block 1108, in some embodiments, a predetermined time period passes and the cleaning cycle being executed by the system may run to its completion. In some embodiments, a cleaning cycle may be approximately 10 seconds, 30 seconds, one minute, two minutes, five minutes, or ten minutes long, including one or more periods of executing a cleaning mode and/or one or more periods of executing a rinse mode. After the predetermined period of time has passed, computing elements such as computing element 100 may determine that a cleaning cycle is complete and may generate a signal to cause the system to return to shower mode.

Alternately, at block 1110, in some embodiments, the system may detect that water pressure is below a predetermined threshold required for a cleaning cycle. As discussed above, a shower-cleaning system such as system 100 may require that water be provided from an associated/integrated shower system in order to provide water for components of the shower-cleaning system to properly function. For example, water pressure may be required in order to actuate a cleaning nozzle, cause a cleaning nozzle to rotate or otherwise move about, open one or more valves, effectively mix water with cleaner, draw cleaner into a flow path via the Venturi effect, spray/project water at sufficient pressure and speed to reach intended portions of a shower enclosure, or enable any other functionality of a shower-cleaning system. As discussed above with respect to block 1102, a user may first be required to turn on the flow of water to a shower system before a cleaning cycle of an associated shower-cleaning system may be activated.

In some embodiments, a shower-cleaning system may comprise one or more pressure sensors configured to detect water pressure and to generate and transmit signals in accordance with the detected water pressure. Computing elements such as computing element 100 may be configured to receive the signals indicative of the water pressure and to determine whether the water pressure is below one or more predefined minimum thresholds required for a cleaning cycle to operate. If computing elements such as computing element 100 determine that the water pressure is below one or more predefined minimum thresholds, then the computing elements may generate a signal to cause the system to cease and/or wind down a cleaning cycle and return to shower mode.

In some embodiments, water pressure may be caused to fall below a predetermined minimum threshold if a user turns off the flow of water to the shower-cleaning system before or during a cleaning cycle. In some embodiments, water pressure may fall below a threshold because of a clogged house filter, a clogged flow restrictor, a broken well pump, a broken water main, a broken supply pipe, frozen supply pipe, and/or an open fire hydrant.

Alternately, at block 1112, in some embodiments, the system may receive an input from a user including an instruction to return to a shower mode. In some embodiments, shower mode and cleaning modes may be mutually exclusive, such that an instruction to return to a shower mode may include an instruction to cease or wind down a cleaning mode or a cleaning cycle. The input received at block 1112 may be received in a same or similar manner as discussed above with respect to the input received; for example, a user may enter an input into an electronic receiving means such as a button, keypad, switch, or touchpad, or a user may alternately turn, press, or otherwise actuate one or more mechanical switches or knobs.

In some embodiments, block 1114 may follow from any one or more of blocks 1108, 1110, and 1112.

At block 1114, in some embodiments, in accordance with one or more of the occurrences explained above with respect to blocks 1108, 1110, and 1112, the system may divert water away from shower-cleaning components to return the system to conventional shower components such, such that a shower mode may resume. In some embodiments, diverting water away from shower-cleaning components may include opening, closing, actuating, or otherwise manipulating one or more valves and/or diverters in order to cause water to cease to flow along a flow path toward a cleaning nozzle and potentially to cause water to flow along a flow path toward a shower face. In the example of system 100 in FIG. 1, computing element 110 may send a signal to solenoid 108 that causes diverter 104 and/or valve 106 to redirect the flow of water from the flow path terminating at cleaning nozzle 124 to the flow path terminating at shower face 120. In some embodiments, rather than controlling a valve or diverter via electronic control, a diverter or valve may physically displaced or manipulated by a user's physical input.

In some embodiments, when a cleaning cycle has ended, a shower-cleaning system may emit or display one or more audible or visual alerts or signals indicating that the cycle has ended, such as a signal intended to alert a user that the cycle has ended such that the user may turn off the flow of water to the shower system.

After a cleaning cycle has completed and shower mode has resumed, a user may then, in some embodiments, turn off the flow of water to the shower system.

In some embodiments, if a user enters an input to begin a cleaning cycle when a cleaning cycle is already in progress, then the cleaning cycle may be extended or restarted. In some embodiments, entering such an input during a cleaning cycle may have no effect.

In some embodiments, the system may end or wind down a cleaning cycle before it has fully completed if the system detects that one or more batteries of the system are running low. In some embodiments, the system may initially check battery voltage and only complete a cycle if battery voltage is above a predetermined threshold voltage. If the battery voltage is below predetermined threshold voltage, the system may refrain from executing a cycle and instead may output an audible and/or visual alarm, or may take no action.

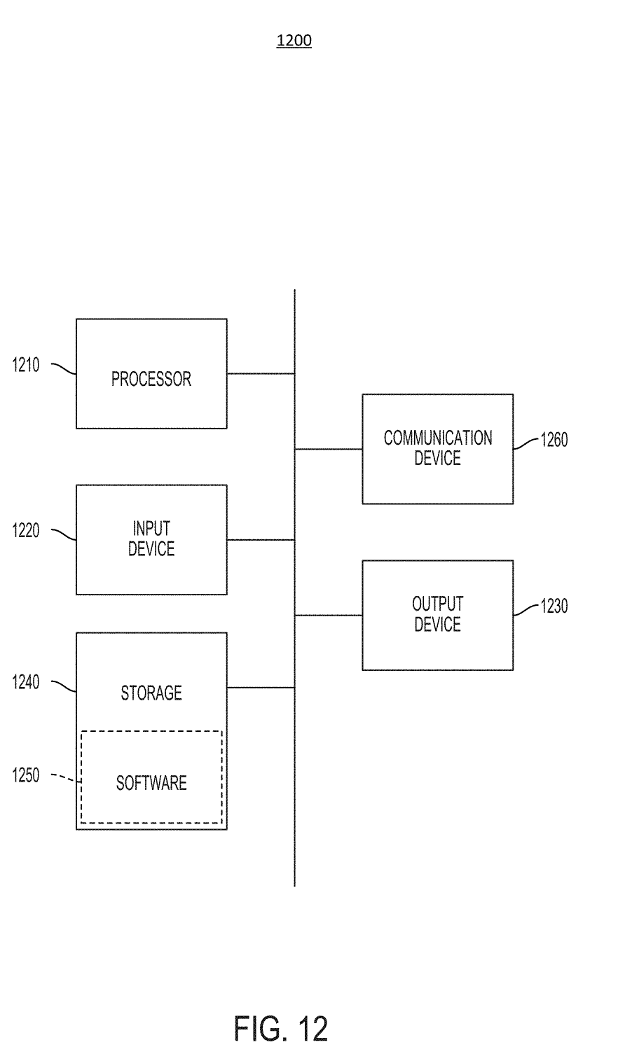

FIG. 12 illustrates an example of a computer in accordance with some embodiments. Computer 1200 can be a component of a shower-cleaning system, such as system 100 described above with respect to FIG. 1. In some embodiments, computer 1200 is configured to execute a method for cleaning a shower, such as all or part of method 1100.

Computer 1200 can be a host computer connected to a network. Computer 1200 can be a client computer or a server. As shown in FIG. 12, computer 1200 can be any suitable type of microprocessor-based device, such as a personal computer; workstation; server; or handheld computing device, such as a phone or tablet. The computer can include, for example, one or more of processor 1210, input device 1220, output device 1230, storage 1240, and communication device 1260.

Input device 1220 can be any suitable device that provides input, such as a touch screen or monitor, keyboard, mouse, or voice-recognition device. Output device 1230 can be any suitable device that provides output, such as a touch screen, monitor, printer, disk drive, or speaker.

Storage 1240 can be any suitable device that provides storage, such as an electrical, magnetic, or optical memory, including a RAM, cache, hard drive, CD-ROM drive, tape drive, or removable storage disk. Communication device 1260 can include any suitable device capable of transmitting and receiving signals over a network, such as a network interface chip or card. The components of the computer can be connected in any suitable manner, such as via a physical bus or wirelessly. Storage 1240 can be a non-transitory computer-readable storage medium comprising one or more programs, which, when executed by one or more processors, such as processor 1210, cause the one or more processors to execute methods described herein, such as all or part of method 1100.

Software 1250, which can be stored in storage 1240 and executed by processor 1210, can include, for example, the programming that embodies the functionality of the present disclosure (e.g., as embodied in the systems, computers, servers, and/or devices as described above). In some embodiments, software 1250 can include a combination of servers such as application servers and database servers.

Software 1250 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 1240, that can contain or store programming for use by or in connection with an instruction execution system, apparatus, or device.

Software 1250 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 1200 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1200 can implement any operating system suitable for operating on the network. Software 1250 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

FIG. 13 shows an exploded view of a multi-port diverter system in accordance with some embodiments. Multi-port diverter system 1300 may, in some embodiments, be included in or used in conjunction with one or more multi-valve diverters, such as diverter 106 as discussed above with respect to FIG. 1.

In some embodiments, multi-port diverter system 1300 may include shower arm 1302, which is fluidly connected to shower arm 1302 and may share some or all of the properties of shower arm 102 as discussed above with reference to FIG. 1.

In some embodiments, multi-port diverter system 1300 comprises shower face 1304, which is fluidly connected to shower arm 1302 and may share some or all of the properties of shower face 120 as discussed above with reference to FIG. 1.

In some embodiments, multi-port diverter system 1300 comprises cleaning nozzle 1306, which is fluidly connected to shower arm 1302 and may share some or all of the properties of cleaning nozzle 124 as discussed above with reference to FIG. 1.

In some embodiments, multi-port diverter system 1300 comprises outlet 1308, which may be any outlet fluidly connected to shower arm 1302. In some embodiments, outlet 1308 may be configured to allow water to flow out gently and/or slowly and/or under lower water pressure into a shower enclosure when water is not flowing out of either shower face 1304 or cleaning nozzle 1306. In some embodiments, outlet 1308 may be configured to output water when a shower-cleaning system is in a pause mode and/or a pause period between a cleaning more and a rinse mode of a cleaning cycle. In some embodiments, outlet 1308 may share some or all of the properties of pressure outlet 134 as discussed above with reference to FIG. 1.

In some embodiments, multi-port diverter system 1300 may be configured such that water flows to one of shower face 1304, cleaning nozzle 1306, or outlet 1308, but not to two or more at once. In some embodiments, the flow of water may be controlled by rotating disc 1310 and multi-port disc 1312.

In some embodiments, rotating disc 1310 may be a circular disc having one or more openings or ports. In the example shown, the circular rotating disc 1310 has two pie-shaped openings that are symmetrically positioned across from one another and that each account for roughly one-eighth of the area of rotating disc 1310. Rotating disc 1310 may be configured to be disposed against a face of multi-port disc 1312.

In some embodiments, multi-port disc may be a circular disc having two or more openings or ports. In the example shown, the circular multi-port disc 1312 has eight pie-shaped openings that are positioned radially about the disc and that each account for roughly one-eighth of the area of multi-port disc 1312. In some embodiments, multi-port disc 1312 may be configured such that one or more ports of multi-port disc 1312 may align with one or more ports of rotating disc 1310 when rotating disc 1310 is rotated to certain alignments.

When rotating disc 1310 is rotated to certain alignments, fluid may be able to flow through the aligned ports, while fluid may not be allowed to flow past the two discs when one or more ports of the two discs are not aligned. In some embodiments, rotating disc 1310 may be rotated under power of electronic controls, while in some embodiments it may be manually or mechanically rotated by a user.

In the example shown in FIG. 13, rotating disc 1310 has 2 ports through which water may simultaneously flow, and multi-port disc 1312 has 8 ports, two of which may simultaneously respectively align with the two ports on rotating disc 1310. In some embodiments, the ports labeled (A) may be fluidly connected to shower face 1304, the ports labeled (B) and (D) may be fluidly connected to cleaning nozzle 1306, and the ports labeled (C) may be fluidly connected to outlet 1308. Accordingly, as rotating disc 1310 rotates, system 1300 may thus progress through a from a shower mode corresponding to the (A) ports, to a cleaning mode corresponding to the (B) ports, to a pause mode corresponding to the (C) ports, and then to a rinse mode corresponding to the (D) ports. In some embodiments, the fluid connection between the (B) ports and cleaning nozzle 1306 may comprise an in-flow for cleaner, while the fluid connection between the (D) ports and cleaning nozzle 1306 may not comprise an in-flow for cleaner.

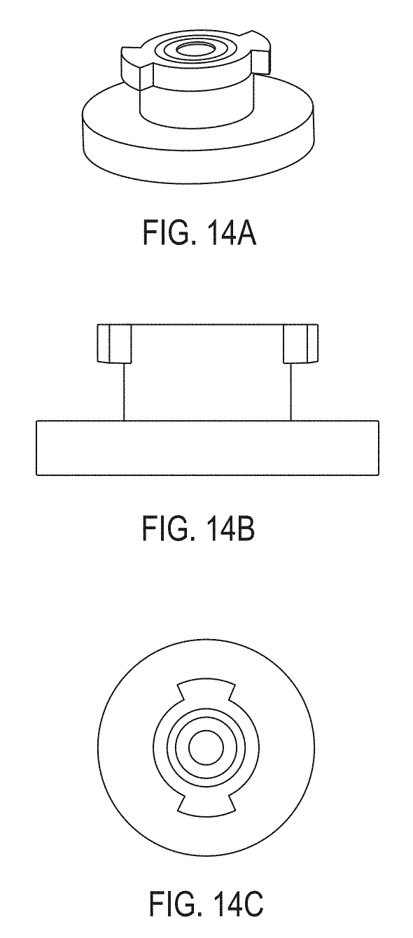

FIGS. 14A, 14B, and 14C show different views of a quarter-turn connector mechanism in accordance with some embodiments. In some embodiments, a quarter-turn connector mechanism may be disposed on a bottle or bag of cleaner, such as at a top of a bottle or bag of cleaner, and may be used to connect the bottle or bag of cleaner to a shower-cleaning system.

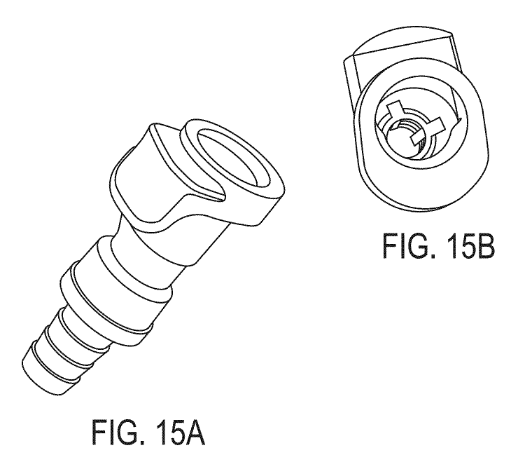

FIGS. 15A and 15B show different views of a push-in connector mechanism in accordance with some embodiments. In some embodiments, a push-in connector mechanism may be used to connect a bottle or bag of cleaner to a shower-cleaning system. In some embodiments, a push-in connector mechanism may allow one-handed insertion and/or removal of the connected bottle by inserting a male portion into a female portion. In some embodiments, a push-in connector may be releasable by depressing a button.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

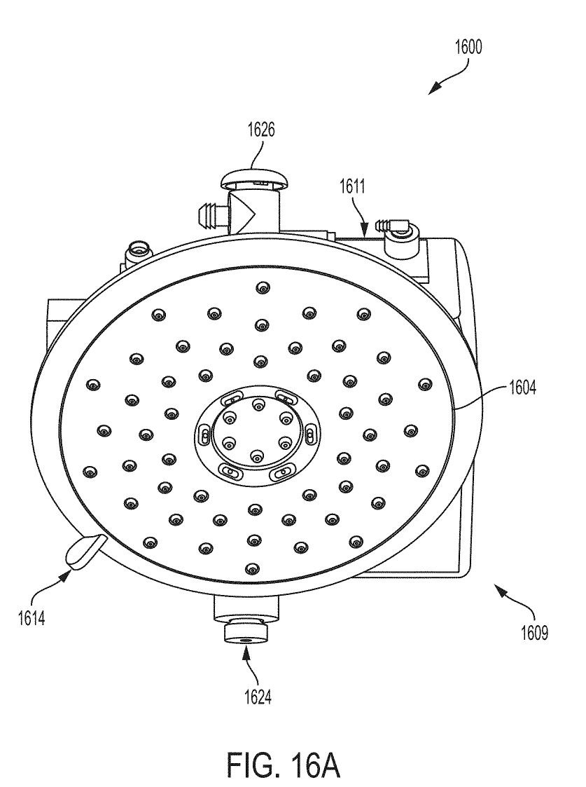

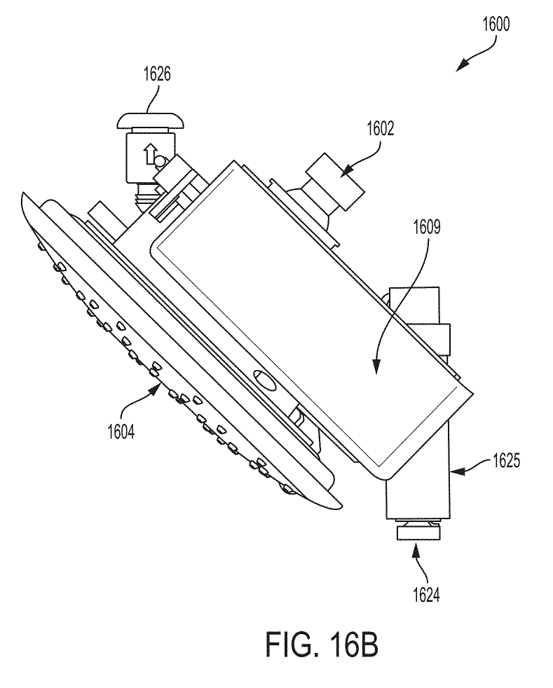

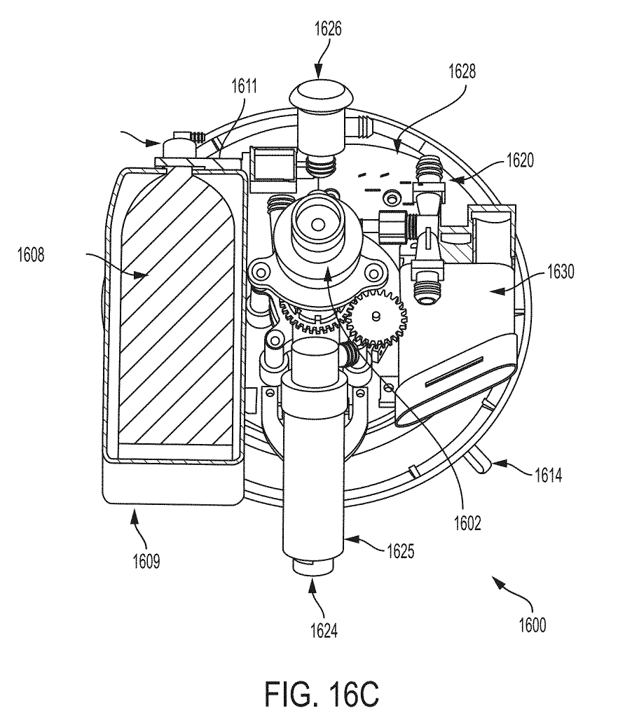

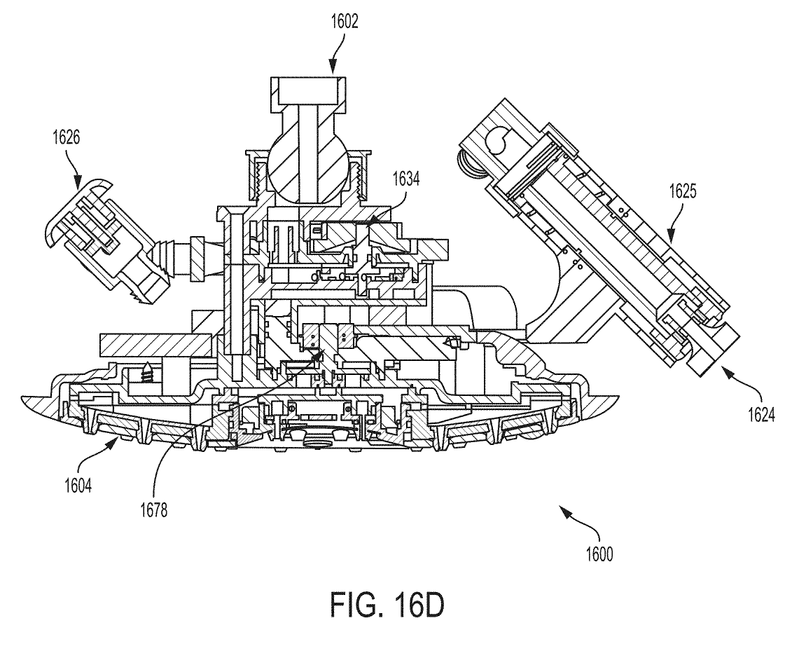

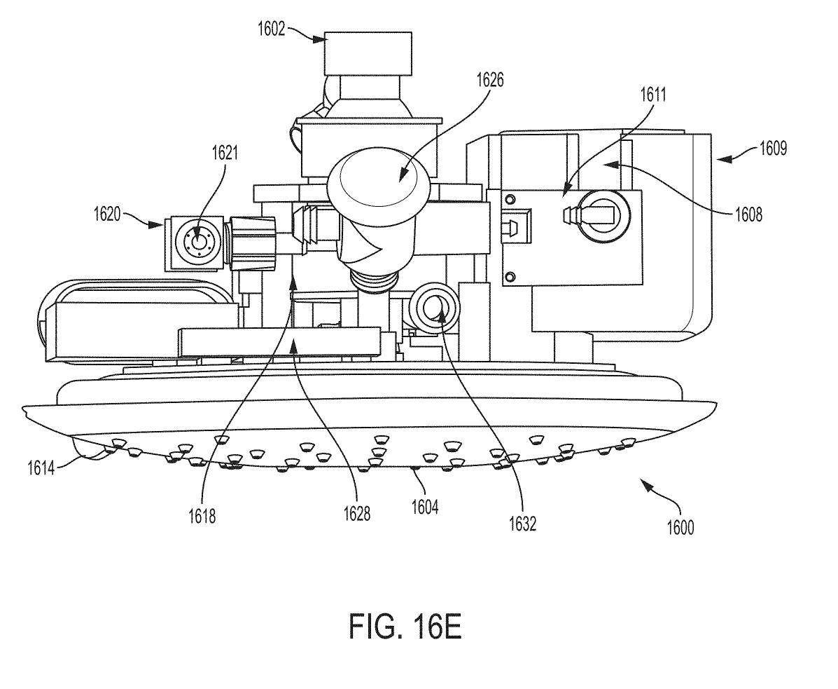

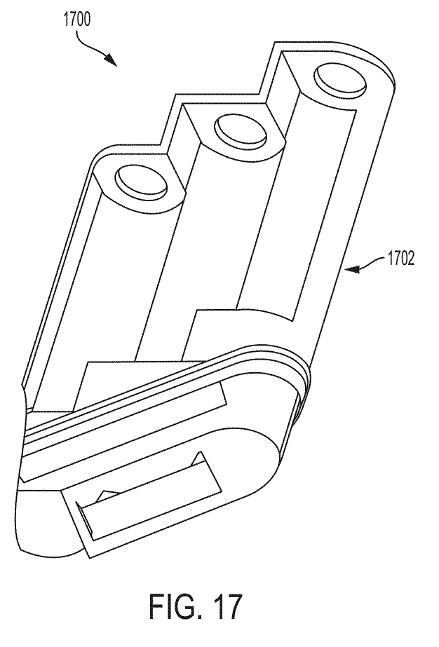

FIGS. 16A-16E depict various views of shower-cleaning showerhead 1600, in accordance with some embodiments. Shower-cleaning showerhead 1600 may be included in shower-cleaning system 100 as discussed above, and it may comprise any one or more of the elements of shower-cleaning system 100 discussed above. FIG. 16A is an external front view of shower-cleaning showerhead 1600; FIG. 16B is a side view of shower-cleaning showerhead 1600; FIG. 16C is a back cutaway view of shower-cleaning showerhead 1600; FIG. 16D is a cross-sectional view of shower-cleaning showerhead 1600; and FIG. 16E is a top view of shower-cleaning showerhead 1600.

In some embodiments, shower-cleaning showerhead 1600 comprises shower face 1604, which may share some or all of the properties of other shower faces described herein, such as shower face 120 as discussed above with reference to FIG. 1.

In some embodiments, shower-cleaning showerhead 1600 comprises cleaning nozzle 1624, which may share some or all of the properties of other cleaning nozzles described herein, such as cleaning nozzle 124 as discussed above with reference to FIG. 1. In some embodiments, cleaning nozzle 1624 may face downward from showerhead 1600. In some embodiments, cleaning nozzle 1624 may comprise a pop-out nozzle head configured to selectively pop out from and retreat into pop-out spray body 1625, which may in some embodiments comprise a cylindrical shape. In some embodiments, cleaning nozzle 1624 may be forced inward and/or outward from pop-out spray body 1625 by one or more springs inside pop-out spray body 1625.

In some embodiments, shower-cleaning showerhead 1600 comprises cleaner pouch 1608, which may share some or all of the properties of other cleaner components described herein, such as cleaner 128, and a container therefor as described above with respect to FIG. 1, or of cleaner bottle 208 as described above with reference to FIG. 2. In some embodiments, cleaner pouch 1608 may be a flexible pouch configured to compress as cleaner is evacuated from inside the pouch. In some embodiments, cleaner pouch 1608 may be configured to be received inside tray cartridge 1609, which may in some embodiments be formed as part of a housing of showerhead 1600 or separately from a housing of showerhead 1600. In some embodiments, tray cartridge 1609 may be mounted to showerhead 1600 by mounting plate 1611. In some embodiments, tray cartridge 1609 may be configured to be able to be opened and/or closed by a user to replace and/or refill cleaner pouch 1608 as needed

In some embodiments, shower-cleaning showerhead 1600 comprises handle 1614, which may share some or all of the characteristics of other input devices described herein, such as input device 116 as described above with reference to FIG. 1 and/or with knob 214 as described above with reference to FIG. 2.

In some embodiments, shower-cleaning showerhead 1600 comprises diverter 1618, which may share some or all of the properties of other diverters described herein, such as diverter 104 as described above with reference to FIG. 1. In some embodiments, diverter 1618 may comprise a four-outlet diverter, such as described above with reference to FIG. 1. In some embodiments, diverter 1608 may be fluidly connected to receive a flow of water from water inlet 1602 and to deliver the flow of water selectably to shower face 1604 and/or and cleaning nozzle 1606. Diverter 1608 may be configured to selectably divert water to one of shower face 1604 or cleaning nozzle 1624, or both. In a similar manner as described above with reference to FIG. 1, water may be directed to shower face 1604 during a shower mode and may be directed to cleaning nozzle 1624 during a cleaning mode and/or a rinse mode.

In some embodiments, shower-cleaning showerhead 1600 includes Venturi 1620, which may share some or all of the properties other Venturis described herein, such as of Venturi 130 as described above with reference to FIG. 1. In some embodiments, Venturi 1620 may be fluidly connected to diverter 1618 and cleaning nozzle 1624, and it may be positioned between them. As water flows through Venturi 1606 from diverter 1618 toward cleaning nozzle 1624, pressure may be created that draws cleaner fluid into the water flow from pouch 1608, which may be fluidly connected to Venturi 1620 (e.g., connected by connector 1611).

In some embodiments, Venturi 1620 may comprise pressure-compensating regulator 1621, as shown for example in FIG. 16E. In some embodiments, pressure-compensating regulator 1621 may be configured to compensate for high water pressure and to restrict the flow of water in response to higher water pressures, therefore mitigating the increase in flow rate that may otherwise be caused by an increase in water pressure. In some embodiments, pressure-compensating regulator 1621 may comprise an elastomer (e.g., an o-ring shaped part) configured to be influenced by increased water pressure to expand and a barrier comprising one or more through-holes through which water may flow. As the elastomer expands due to increased water pressure, it may block an increased number of the through-holes in the barrier, thereby decreasing the available area for the flow path of the water and maintaining the flow rate or mitigating the rate at which the flow rate increases as water pressure increases

In some embodiments, shower-cleaning showerhead 1600 includes vacuum breaker 1626, which may share some or all of the properties other backflow prevention devices described herein, such as backflow prevention device 118 as described above with reference to FIG. 1. As shown, vacuum breaker may be mounted on a top side of showerhead 1600.

In some embodiments, shower-cleaning showerhead 1600 includes computing element 1628, which may in some embodiments share some or all of the properties other computing elements disclosed herein, such as computing element 110 discussed above with respect to FIG. 1 and/or computer 1200 discussed above with respect to FIG. 12. As shown in FIG. 16C, computing element 1628 may in some embodiments be disposed inside a housing of showerhead 1600. In some embodiments, computing element 1628 may comprise a printed circuit board. In some embodiments, computing element 1628 may be configured to send and/or receive electrical signals to/from one or more components of showerhead 1600, including for the purpose of electronically controlling one or more functions of showerhead 1600.

In some embodiments, shower-cleaning showerhead 1600 includes battery compartment 1630, which may in some embodiments share some or all of the properties of other battery housings, compartments, or trays disclosed herein. In some embodiments, battery compartment 1630 may be disposed inside a housing of showerhead 1600. In some embodiments, battery compartment 1630 may be concealed by a movable door or barrier, such as battery door 216 described above with reference to FIG. 2B. In some embodiments, battery compartment 1630 may be configured to house one or more batteries to provide power to diverters and/or solenoids of showerhead 1600 and/or to processing components of showerhead 1600 (e.g., computing element 1628). In some embodiments, all or part of battery compartment 1630 may be configured to be able to be quickly removed by a user, such as by being releasable in accordance with a user pressing a button, such that a user may replace batteries for the system as needed.

In some embodiments, shower-cleaning showerhead 1600 includes outlet for cleaner diverter valve 1632, which may define a flow path that water may take once it is diverted from inside a diverter to be used for a cleaning cycle. In some embodiments, outlet for cleaner diverter valve 1632 may be an outlet through which water may travel before traveling to a vacuum breaker such as vacuum breaker 1626.

In some embodiments, shower-cleaning showerhead 1600 includes clean system diverter 1634, which may selectively divert water either toward a flow path corresponding to a cleaning system or toward a flow path corresponding to a shower face. If water is diverted to a shower face, another diverter downstream (e.g., a four-function diverter) of clean system diverter 1364 may allow a user to switch between different shower face settings, such as fine spray, soft spray, massage, jet, etc. In some embodiments, clean system diverter may include four pathways, each pathway comprising two opposing mirrored openings, for a total of eight sections.

FIG. 17 depicts battery compartment 1700, in accordance with some embodiments. In some embodiments, battery compartment 1700 may be included in any of the showerheads and/or shower-cleaning systems disclosed herein, such as showerhead 1600 discussed above with reference to FIGS. 16A-16E. In some embodiments, battery compartment 1700 may comprise any one or more of the elements of any other battery housings, compartments, or trays disclosed herein, such as battery compartment 1630 discussed above with reference to FIG. 16C. As shown in FIG. 17, battery compartment 1700 may comprise cartridge tray 1702, which may comprise one or more slots in which a respective battery may be placed. In some embodiments, tray 1702 may be configured such that batteries may be positioned in a staggered arrangement with respect to one another, which may make removing/inserting batteries easier and may allow battery compartment 1700 to have a shape that fits easily inside a housing of a shower cleaning system and/or of a showerhead.

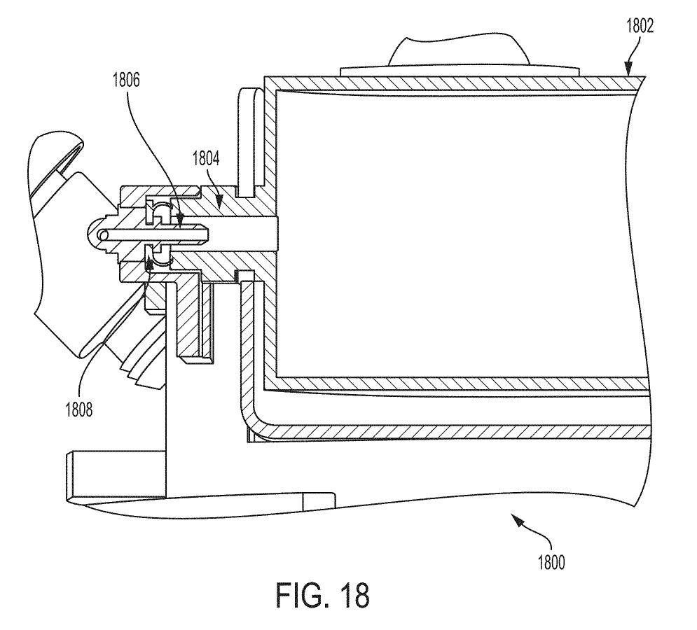

FIG. 18 depicts cleaner pouch connection 1800, in accordance with some embodiments. As shown, connection 1800 may comprise cleaner pouch 1802, outlet 1804, needle 1806, and sealing bulb 1808. In some embodiments, connection 1800 may share some or all of the properties of any of the other connection systems and/or mechanisms for cleaner supplies, bottles, pouches, bags, or the like, described elsewhere herein. For example, in some embodiments, pouch 1802 may share some or all of the properties of cleaner pouch 1608 described above with reference to FIG. 16C. As shown, pouch 1802 may comprise outlet 1804, which may be configured to fluidly connect (e.g., by threaded connection, press-fit connection, quarter-turn connection, or any other suitable connection mechanism or technique) in order to allow cleaning fluid to empty from pouch 1802 into a fluid flow path of a shower-cleaning system. As shown, outlet 1804 may be configured to connect to a system inlet comprising needle 1802 and bulb 1808. As pouch 1802 is pressed toward the inlet of the system, needle 1806 may puncture a lid of pouch 1806 and bulb 1808 may form a water-tight seal against the end surface of outlet 1804. Once pouch 1802 is connected to a shower cleaning system in which connection 1800 may be disposed, a fluid connection between pouch 1802 and a fluid flow path of the shower-cleaning system may be established through a channel through needle 1806.

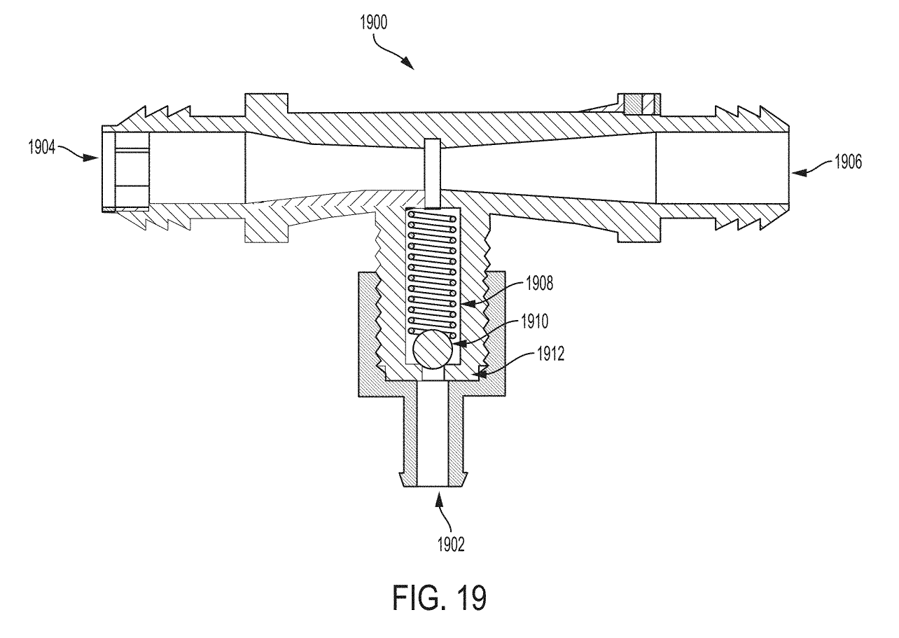

FIG. 19 depicts Venturi 1900, in accordance with some embodiments. In some embodiments, Venturi 1900 may be any valve configured to create suction due to the Venturi effect. In some embodiments, Venturi 1900 may share some or all of the properties of other Venturis described herein, such as cleaning Venturi 130 as discussed above with reference to FIG. 1 or Venturi 1620 as discussed above with reference to FIG. 16C. In some embodiments, Venturi 1900 may be disposed in a shower-cleaning system such as any of the shower cleaning systems disclosed herein. In some embodiments, Venturi 1900 may be configured to draw cleaning fluid into a water flow path in order to output mixed water and cleaning fluid from a cleaning nozzle of a shower cleaning system.

In some embodiments, Venturi 1900 may define a water flow path from water inlet 1904 to outlet 1906. In some embodiments, Venturi 1900 may comprise cleaning fluid inlet 1902 configured to be fluidly connected to and draw cleaning fluid into inlet 1902 and toward the flow path between inlet 1904 and outlet 1906. In some embodiments, the dimensions of Venturi 1900 may be optimized, selected, and/or adjusted in accordance with a water pressure of a shower-cleaning system, in order to cause a desired volume of cleaning fluid to be drawn into the flow path for the given water pressure. In some embodiments, Venturi 1900 may comprise one or more nozzles and/or collars that may define one or more constrictions that may affect a flow rate of water and/or cleaner fluid through Venturi 1900. In some embodiments, the dimensions of a collar and/or nozzle may be optimized, selected, and/or adjusted as discussed above. By causing a desired volume of cleaning fluid to be drawn into the flow path of Venturi 1900, Venturi 1900 may thus be used to select and maintain a concentration of cleaning solution in the flow path for a cleaning cycle and/or rinse cycle of a shower cleaning system.

In some embodiments, Venturi 1900 comprises spring 1908, ball 1910, and o-ring 1912. As cleaner fluid or other fluid flows into inlet 1902, ball 1910 may be forced upward and spring 1908 may be compressed, opening a flow path through o-ring 1912. However, as spring 1908 forces ball 1910 toward and against o-ring 1912, a seal may be created to prevent back-flow of cleaner fluid and/or other fluids out from inlet 1902. In some embodiments, any other suitable back-flow prevention mechanism may be used to prevent back-flow of cleaner fluid and/or other fluids out from inlet 1902.

In some embodiments, Venturi 1900 may be configured such that the smallest-diameter portion of the flow path between inlet 1904 and outlet 1906 has a diameter Φ. In some embodiments, the location along the flow path between inlet 1904 and outlet 1906 at which cleaner fluid is injected from inlet 1902 (e.g., the confluence of the two flow paths in Venturi 1900) may be located downstream from the point at which the flow path between inlet 1904 and outlet 1906 has diameter Φ. In some embodiments, the injection location may be downstream from the confluence location by a distance of 0.5*Φ.

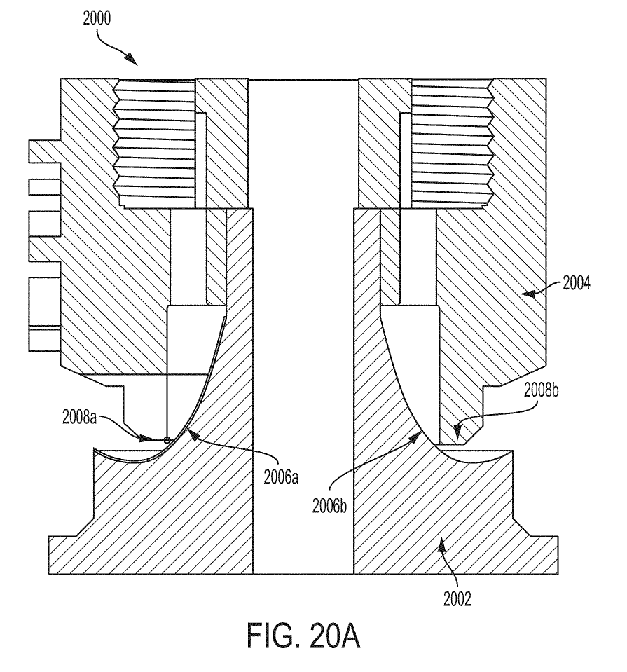

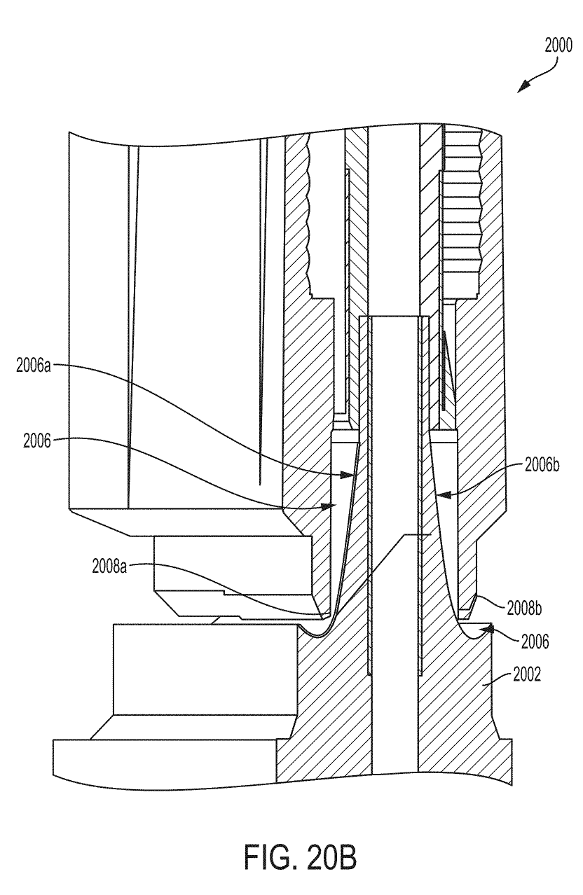

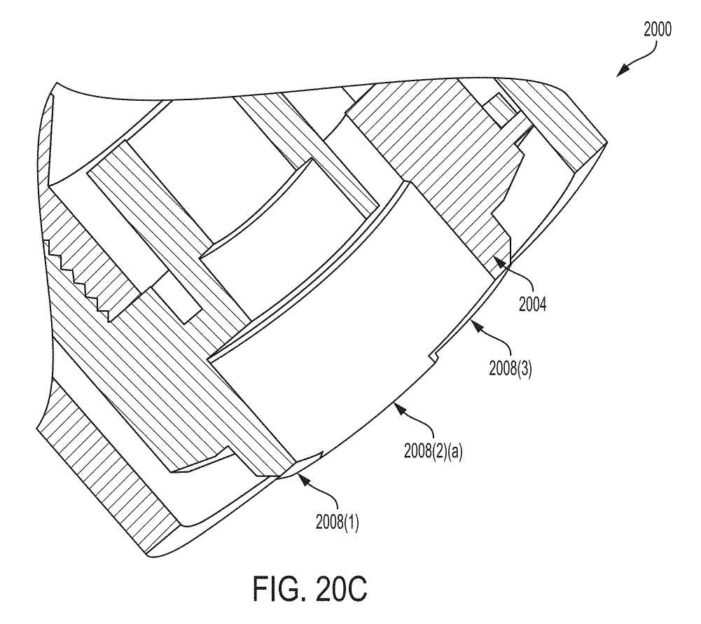

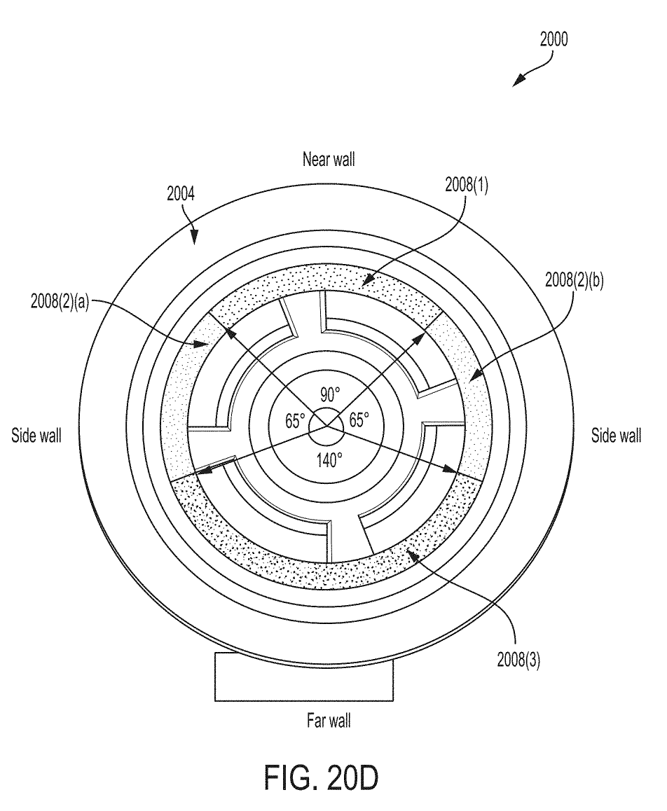

FIGS. 20A-20D depict various views of nozzle 2000, in accordance with some embodiments. Nozzle 2000 may be included in shower-cleaning system 100 as discussed above, and it may comprise any one or more of the elements of shower-cleaning system 100 discussed above, and/or of any of the nozzles discussed there or elsewhere herein. In some embodiments, nozzle 2000 may be configured to dispense water and/or cleaning fluid as part of a cleaning and/or rinsing cycle of a shower-cleaning showerhead. FIG. 20A is cross-sectional view of nozzle 2000; FIG. 20B is an angled cross-sectional view of nozzle 2000; FIG. 20C is a cross-sectional view of nozzle 2000; and FIG. 20D is a bottom view of nozzle 2000.

FIG. 20A is cross-sectional view of nozzle 2000, and FIG. 20B is an angled-cross sectional view of nozzle 2000. As shown in FIGS. 20A and 20B, nozzle 2000 may comprise collar 2004 and nozzle insert 2002. Nozzle insert 2002 may comprise upper surface 2006 (shown in the cross-sectional views by lines 2006a and 2006b), and collar 2004 may comprise lower surface 2008 (shown in the cross-sectional views by lines 2008a and 2008b). In some embodiments, the space between upper surface 2006 of nozzle insert 2002 and lower surface 2008 of collar 2004 may form an opening (e.g., a slit, channel, gap, etc.) through which water and/or cleaning fluid may exit from nozzle 2000 and be sprayed into a shower enclosure to be cleaned.

In some embodiments, one or both of upper surface 2006 and lower surface 2008 may be annular (e.g., ring-shaped), and may surround a central channel of nozzle 2000, as shown for example in FIG. 20B. As further shown in FIGS. 20A and 20B, upper surface 2006 may have a curved cross-sectional shape (as shown by the curved lines 2006a and 2006b) that may guide a flow of water and/or cleaner fluid along the curve of upper surface 2006 and through the gap defined between upper surface 2006 and lower surface 2008. As water and/or cleaner fluid is forced through the gap between upper surface 2006 and lower surface 2008, the water and/or cleaner fluid may form a sheet that is sprayed into the shower enclosure.

FIG. 20C is cross-sectional view of nozzle 2000, focusing on collar 2004 and showing how bottom surface 2008. As shown in FIG. 20C, bottom surface 2008 of collar 2004 may have a variable-height surface. That is, some portions of bottom surface 2008 may extend further downward toward nozzle insert 2002 (not shown) than other portions of bottom surface 2008.

As shown in FIG. 20C, bottom surface 2008 may in some embodiments comprise a plurality of portions having different heights, thereby extending toward nozzle insert 2002 by different distances and causing the gap between nozzle insert 2002 and collar 2004 to be variable in width. In some embodiments, the variable-width gap may be configured to direct different amounts of water in different directions and/or toward different parts of a shower enclosure. For example, in a rectangular shower enclosure, a first amount of water may be directed toward a back/near wall, a second amount of water may be directed in both sideways directions toward side walls, and a third amount of water may be directed toward a distant far wall. In some embodiments, the amount of water directed in each direction may be optimized in accordance with different shapes or shower enclosures (e.g., more or less water may be desired to be forced toward walls that are further or toward walls that are closer), and dimensions of a collar such as collar 2004 may be accordingly selected. In some embodiments, a larger amount of water may be caused to spray toward a more distant wall than a second, smaller amount of water that may be caused to spray toward a nearer wall.

In the example of FIGS. 20C and 20D, bottom surface 2008 comprises four separate portions: portion 2008(1) configured to face a near wall, portions 2008(2)(a) and 2008(2)(b) configured to face side walls, and portion 2008(3) configured to face a far wall. In some embodiments, portion 2008(1) may extend a first distance toward nozzle insert 2002, portions 2008(2)(a) and 2008(2)(b) may extend a second distance toward nozzle insert 2002, and portion 2008(3) may extend a third distance toward nozzle insert 2002. In some embodiments, portion 2008(1) may extend further than portion 2008(3), causing a larger gap to face the far wall and for a greater amount of water and/or cleaner fluid to be sprayed toward the far wall as compared to the near wall. In some embodiments, this may improve the thoroughness of the cleaning of the far wall and may prevent excessive splashing on the near wall. In some embodiments, the variation in the width of the gap may be more than 0.01 mm, more than 0.1 mm, more than 1 mm, more than 0.5 mm, or more than 1 cm.

In some embodiments, a varying-height bottom surface such as bottom surface 2008 may have more than four distinct portions. In some embodiments, when bottom surface 2008 is annular as in FIGS. 20A-20D, the radial distances for which each portion accounts may be varied for example in accordance with a placement of nozzle 2000 and/or a shape of a shower enclosure in which nozzle 2000 is located. In some embodiments different portions of bottom surface 2008 may be connected by smooth transitions, alternately or in addition to the step-like transitions shown in FIGS. 20C and 20D. In some embodiments, alternately or in addition to collar 2004 having one or more variable-height surfaces, nozzle insert 2002 may have one or more variable-height surfaces configured to cause variation in the width of the gap defined between nozzle insert 2002 and collar 2004; for example, in some embodiments, upper surface 2006 of nozzle insert 2002 may have a variable height by comprising different portions that extend toward collar 2004 by different distances

FIGS. 21 and 22 each depict a respective rotating cleaning nozzle, in accordance with some embodiments. As shown in the figures, FIG. 21 depicts a cleaning nozzle configured to rotate while dispensing cleaning fluid and/or water, and FIG. 22 depicts a cleaning nozzle configured to rotate while dispensing cleaning fluid and/or water.

1. A shower-cleaning showerhead comprising:
a showerhead housing comprising a showerhead face and a cleaning nozzle;
a diverter located inside the showerhead housing and configured to be fluidly connected to a water supply of a shower, the showerhead face, and the cleaning nozzle; and
wherein the cleaning nozzle is configured to be fluidly connected to a supply of a cleaning agent of the showerhead such that the cleaning agent mixes with water of the water supply to create a mixture that flows out of the cleaning nozzle;
wherein the diverter is configured to selectably prevent and allow flow of water of the water supply to each of the shower face and the cleaning nozzle.

2. The showerhead of claim 1, wherein the supply of cleaning agent comprises a container configured to be attached to a receiving portion of the showerhead.

3. The showerhead of claim 2, wherein the container comprises a rigid bottle having an outlet configured to allow the cleaning agent to flow out of the bottle and an inlet configured to allow air to flow into the bottle.

4. The showerhead of claim 2, wherein the container comprises a flexible bag configured to be collapsible.

5. The showerhead of claim 1, wherein the supply of cleaning agent comprises a solid tablet of concentrated cleaning agent configured to dissolve and mix with the water of the water supply.

6. The showerhead of claim 1, comprising an electric pump configured to cause the cleaning agent to flow into the water of the water supply.

7. The showerhead of claim 1, wherein the cleaning agent is configured to flow into the water of the water supply due to suction created by the Venturi effect.

8. The showerhead of claim 1, comprising:
a solenoid included in the diverter; and
a power supply configured to provide current to the solenoid;
wherein selectably preventing and allowing flow of water of the water supply to each of the shower face and the cleaning nozzle comprises providing current to the solenoid to cause a valve of the diverter to be opened or closed.

9. The showerhead of claim 1, comprising a backflow prevention device fluidly connected to the diverter and the cleaning nozzle, wherein the backflow prevention device is positioned between the diverter and the cleaning nozzle and is configured to prevent the flow of the mixture back toward the diverter.

10. The showerhead of claim 1, wherein the cleaning nozzle comprises a variable-width gap configured to dispense water and cleaning solution.

11. The showerhead of claim 10, wherein the variable width gap is configured to dispense a first amount of water in a first direction and a second amount of water in a second direction.

12. A shower-cleaning apparatus, comprising:
a diverter configured to be fluidly connected to a water supply the diverter having a first outlet and a second outlet;
a showerhead face configured to be fluidly connected to the first outlet of the diverter;
a cleaning nozzle configured to be fluidly connected to the second outlet of the diverter, wherein the cleaning nozzle is configured to be fluidly connected to a supply of a cleaning agent such that the cleaning agent mixes with water of the water supply to create a mixture that flows out of the cleaning nozzle;
one or more processors;
an input device configured to receive input from a user and send one or more signals to the one or more processors; and
memory storing instructions executable by the one or more processors to cause the one or more processors to:
detect an input received by the input device, wherein the input comprises an instruction to allow flow of water from the water supply to the cleaning nozzle and to disallow flow of water from the water supply to the showerhead face; and
send a signal to the diverter, in response to detecting the input, configured to cause the diverter to allow flow of water from the water supply to the cleaning nozzle and to disallow flow of water from the water supply to the showerhead face.

13. The shower-cleaning apparatus of claim 12, wherein the signal sent to the diverter is configured to cause current to be provided to a solenoid to cause a valve of the diverter to be opened or closed

14. The shower-cleaning apparatus of claim 12, wherein the input comprises an instruction for the showerhead to begin a cleaning cycle.

15. The shower-cleaning apparatus of claim 12, wherein the input device comprises a button or knob.

16. The shower-cleaning apparatus of claim 12, wherein the input device comprises a remote electronic device configured to transmit a wireless signal regarding the input to the one or more processors.

17. The shower-cleaning apparatus of claim 12, comprising an output device, wherein the instructions executable by the one or more processors to:
in response to receiving the input, cause the output device to generate and output a warning signal to notify a user that the cleaning nozzle is being activated before flow of water to the cleaning nozzle is allowed.
